(19) United States
(12) Patent Application Publication
(10) Pub. No.: US 2026/0251383 A1
(43) Pub. Date: Aug. 27, 2026

(54) COLD WATER TANK ASSEMBLY

(71) Applicant: COWAY CO., LTD., Gongju-si (KR)

(72) Inventors: Kwon Jae LEE, Gongju-si (KR); Jae Man KIM, Gongju-si (KR); Hyun Woo LEE, Gongju-si (KR); Gyeong Jong KIM, Gongju-si (KR); Gyeong Min LEE, Gongju-si (KR); Chung Rae KIM, Gongju-si (KR); Jae Wook CHO, Gongju-si (KR); Chang Min SON, Gongju-si (KR); Jeong Yeon KIM, Gongju-si (KR); In Du CHOI, Gongju-si (KR)

(73) Assignee: COWAY CO., LTD., Gongju-si (KR)

(21) Appl. No.: 18/870,493

(22) PCT Filed: Apr. 7, 2023
(86) PCT No.: PCT/KR2023/004711

§ 371 Date: Nov. 29, 2024

(30) Foreign Application Priority Data
Jun. 30, 2022 (KR) 10-2022-0080419

(51) Int. Cl. F25D 31/00

(52) U.S. Cl. CPC F25D 31/003

(57) ABSTRACT

A cold water tank assembly is disclosed. A cold water tank assembly according to one aspect of the present invention includes: a tank configured to communicate with the outside to enable filtered water to be introduced, cooled, and then discharged; and a refrigerant flow path which is accommodated in the tank and through which refrigerant exchanging heat with the filtered water flows, wherein the refrigerant flow path extends such that one end thereof is located outside the tank and the other end thereof is located inside the tank, so that the refrigerant flow path can be coupled to, while extending therethrough, the tank at a single point.

### TECHNICAL FIELD

The present invention relates to a cold water tank assembly, and more particularly, to a cold water tank assembly capable of minimizing the number of points communicating with the outside while improving cooling efficiency.

### BACKGROUND

As interest in the cleanliness of water for drinking increases, homes equipped with apparatuses for filtering water are increasing. In particular, a filtration apparatus called a water purifier is connected to tap water supplied to a home and is configured to filter the supplied tap water to be suitable for drinking and to discharge it.

Recently, a water purifier with a structure that not only filters the supplied tap water but also can discharge it by adjusting it to a desired temperature by the user is popularly sold. The water purifier as described above filters the supplied tap water, heats or cools the filtered tap water, adjusts it to a temperature desired by the user, and then performs discharging.

The configuration for cooling water may be configured in various forms. For example, as a method for improving cooling efficiency, water is cooled in a form of passing water and a refrigerant for cooling the water into a sealed tank. A flow path through which water flows and a flow path through which refrigerant flows are formed inside the tank, respectively. Water may flow inside the tank and be cooled by heat exchange with the refrigerant.

At this time, the tank is configured to communicate with the outside at a part where water flows in and out and at a part where refrigerant flows in and out. Accordingly, there is a concern that reliable sealing of the tank becomes difficult. In addition, since the refrigerant needs to be heat-exchanged with water and a path of sufficient length to be discharged after flow, there is a risk of increasing the size of the tank and the entire water purifier including it.

Furthermore, as the refrigerant is exposed to the outside of the tank at two points, there is a concern that the heat exchange efficiency between the refrigerant and water may decrease.

Therefore, in the case of a water purifier equipped with a tank, it should be possible to prevent arbitrary outflow of water while maintaining the cooling efficiency of the water introduced into the tank.

Korean Patent Laid-Open Publication No. 10-2002-0093414 titled “WATER PURIFIER WITH MODULATED COOLING UNIT” discloses a cooling coil (evaporator) wound outside a cold water tank.

However, in the case of a water stream type cold water purifier, since the water flowing inside the cold water tank and the refrigerant flowing from the cooling coil exchange heat through the cold water tank, there is a problem in that it is difficult to miniaturize a water purifier because heat exchange efficiency is reduced and a capillary tube configured separately from the cooling coil is required.

Korean Utility Model Publication No. 20-1999-0015417 titled “COOLING SYSTEM OF COOLING DEVICE FOR DRINKING WATER” discloses a refrigerant coil (evaporator) located inside a cold water tank. According to this structure, there is an advantage of high heat exchange efficiency because the water flowing inside the cold water tank and the refrigerant flowing from the cooling coil directly exchange heat.

However, there is a problem in that it is difficult to miniaturize a water purifier because a capillary tube configured separately from the cooling coil is still required. In addition, since both the input side and the discharge side of the evaporator penetrate the cold water tank, there is a problem that the cold water tank structure is complicated by the two sealing structures and the manufacturing cost increases.

Korean Registered Utility Model Document No. 20-0385594 titled “A REFRIGERATION APPARATUS FOR WATER PURIFIER HAVING REDUCED NOISE FROM ITS EVAPORATOR” discloses a structure in which a part of the capillary tube is through-coupled in an evaporator located inside a cold water tank. This structure has the effect of slightly shortening the length of the capillary tube by the length of the capillary tube coupled to the evaporator.

However, since the capillary tube is coupled through only a small portion of the straight part of the input side of the evaporator, there is a problem in that most of the capillary tube is formed separately outside the evaporator as in the past, as well as, since both the input side and the discharge side of the evaporator penetrate the cold water tank, there is still a problem that the cold water tank structure is complicated by the two sealing structures and the manufacturing cost increases.

Meanwhile, Korean Patent Laid-Open Publication No. 10-2020-0069668 titled “EVAPORATOR FOR ICE MAKING” filed by this applicant discloses a “1” shape evaporator of an immersion type ice maker in which a capillary tube penetrates. According to this structure, the size of the ice making system can be reduced by integrating the capillary tube and the evaporator, and the refrigerant path can be simplified by forming the input side and the discharge side of the refrigerant in the same area.

In addition, since the throttling action of the capillary tube is performed at a low temperature due to the endothermic effect of the evaporator, the increase in enthalpy in the throttling action can be suppressed. However, this “1” shape ice-making evaporator is installed in an open ice making room, making it difficult to apply to a cold water evaporator that generates cold water in combination with a cold water tank.

Korean Patent Laid-Open Publication No. 10-2002-0093414 (2002 Dec. 16)

Korean Utility Model Publication No. 20-1999-0015417 (1999 May 15)

Korean Utility Model Publication No. 20-0385594 (2005 May 31)

Korean Patent Laid-Open Publication No. 10-2020-0069668 (2020 Jun. 17)

### SUMMARY OF THE INVENTION

### Technical Problem

The present invention is to solve the above problems, and the present invention is directed to providing a cold water tank assembly having a structure capable of improving cooling efficiency.

The present invention is also directed to providing a cold water tank assembly having a structure in which a communication point with the outside can be minimized.

The present invention is also directed to providing a cold water tank assembly having a structure capable of minimizing an increase in temperature of a refrigerant.

The present invention is also directed to providing a cold water tank assembly having a structure capable of reducing the size thereof.

The present invention is also directed to providing a cold water tank assembly having a structure in which water can be cooled for a sufficient time.

The problems of the present invention are not limited to those mentioned above, and other problems not mentioned will be clearly understood by those of ordinary skill in the art from the following description.

### Technical Solution

According to an aspect of the present invention, provided is a cold water tank assembly, including a tank part configured to communicate with the outside to enable filtered water to be introduced, cooled, and then discharged; and a refrigerant flow path part accommodated in the tank part and through which refrigerant exchanging heat with the filtered water flows, wherein the refrigerant flow path part extends such that one end thereof is located outside the tank part and the other end thereof is located inside the tank part, so that the refrigerant flow path part is coupled to, while extending therethrough, the tank part at a single point.

In this case, a cold water tank assembly may be provided in which the refrigerant flow path part includes a main flow path configured to form a flow path for discharging the refrigerant from the other end of the refrigerant flow path part to the one end of the refrigerant flow path part, and to transfer heat to the refrigerant in a mixed state of liquid and gas; and a sub flow path disposed inside the main flow path, configured to extend in the same direction as the main flow path to form a flow path for introducing the refrigerant flows from the one end of the refrigerant flow path part to the other end of the refrigerant flow path part, and configured to lower the pressure of the refrigerant in a mixed state of liquid and gas or in a liquid state.

In addition, a cold water tank assembly may be provided in which the main flow path includes a first main end positioned inside the tank part and formed closed; and a second main end positioned outside the tank part and formed open, and the sub flow path includes a first sub end positioned adjacent to the first main end inside the tank part and formed open to communicate with the main flow path; and a second sub end positioned outside the tank part and formed open to receive the refrigerant from the outside.

In this case, a cold water tank assembly may be provided in which the tank part includes a tank space configured to accommodate the refrigerant flow path part; and a tank body configured to surround the tank space, and among portions of the main flow path and the sub flow path, a portion disposed in the tank space extends in a spiral shape.

In addition, a cold water tank assembly may be provided in which the main flow path extends to be located adjacent to an inner wall of the tank body surrounding the tank space.

In this case, a cold water tank assembly may be provided in which the tank part includes a tank space configured to accommodate the refrigerant flow path part; and a tank base disposed to cover the tank space from one side, and one end in the extension direction of the refrigerant flow path part is positioned in the tank space and extends to penetrate the tank base, and the other end in the extension direction of the refrigerant flow path part is disposed outside the tank space.

In addition, a cold water tank assembly may be provided in which the refrigerant flow path part includes a main flow path through-coupled to the tank base and having the one end formed closed and the other end formed open; a sub flow path extending along the main flow path inside the main flow path, wherein one end formed open in the extension direction of the sub flow path is disposed adjacent to the one end of the main flow path. and the other end formed open in the extension direction of the sub flow path is exposed to the outside of the tank part; and a branch flow path coupled to the other end of the main flow path to communicate with the main flow path and coupled to a portion adjacent to the other end of the sub flow path.

In this case, a cold water tank assembly may be provided in which the branch flow path includes a first extension extending along the extension direction of the main flow path and coupled to the one end of the main flow path; a second extension extending in a direction different from the first extension and communicating with the first extension to form a flow path through which the refrigerant is discharged; and a branch end forming the other end opposite to the main flow path among ends in the extension direction of the first extension.

In addition, a cold water tank assembly may be provided in which a cross-sectional area of one end, opposite to the main flow path, of ends in the extension direction of the branch end is formed to be less than or equal to a cross-sectional area of the sub flow path, so that communication between the inside and the outside of the main flow path is blocked.

In this case, a cold water tank assembly may be provided in which the main flow path includes a main hollow formed as a space extending between the one end and the other end, the sub flow path includes a sub hollow formed as a space extending between the one end and the other end, and through which the refrigerant introduced from the outside flows, and the one end of the sub flow path communicates with the main hollow, so that the refrigerant is introduced through the other end of the sub flow path, flows through the sub hollow, and flows out to the main hollow through the one end.

In addition, a cold water tank assembly may be provided in which the refrigerant flowing out from the sub hollow flows through the main hollow and flows out into the branch flow path through the other end of the main flow path.

In this case, a cold water tank assembly may be provided in which the branch flow path includes a first extension coupled to the other end of the main flow path to communicate with the main hollow and through which the sub flow path passes; and a second extension communicating with the first extension to form a passage through which the refrigerant flowing out from the other end is discharged to the outside.

In addition, a cold water tank assembly may be provided in which the tank part includes a tank space through which the filtered water flows and which accommodates the refrigerant flow path part; a tank body configured to surround the tank space from the outer circumferential direction; and a flow path forming part disposed in the tank space to face the tank body with the refrigerant flow path part interposed therebetween to form a space in which the introduced filtered water flows.

In this case, a cold water tank assembly may be provided in which the flow path forming part includes a plurality of membrane members extending in the longitudinal direction of the tank body and stacked apart from each other in the height direction of the tank body; and a column member extending in the height direction of the tank body and coupled to each of the plurality of membrane members.

In addition, a cold water tank assembly may be provided in which the membrane member includes a first end forming one end in the extension direction thereof, and positioned adjacent to the refrigerant flow path part; and a second end forming the other end in the extension direction thereof, and positioned spaced apart from the refrigerant flow path part.

In this case, a cold water tank assembly may be provided in which the flow path forming part includes a flow space positioned between the second end and the refrigerant flow path part, and in which the filtered water flowing in one membrane member of adjacent membrane members flows out to another membrane member; and a separation space communicating with the flow space, and formed between adjacent membrane members and in which the filtered water flows.

In addition, a cold water tank assembly may be provided in which the second ends of the membrane members adjacent to each other are disposed to be biased to different sides along the longitudinal direction of the tank body.

### Advantageous Effects

According to the above configuration, the cooling efficiency of the cold water tank assembly according to an exemplary embodiment of the present invention can be improved.

First, a tank space through which purified water is introduced and flows is formed inside a tank part. A refrigerant flow path part forming a flow path through which a refrigerant heat-exchanged with purified water flows is accommodated in the tank space. The refrigerant flow path part includes a main flow path through which the refrigerant heat-exchanged with the purified water flows by being exposed to the tank space, and a sub flow path through which a refrigerant to be heat-exchanged with the purified water is introduced. The main flow path and the sub flow path communicate.

In an embodiment, the sub flow path may be provided in the form of a capillary tube formed to have a cross-sectional area smaller than that of the main flow path. The sub flow path extends from the outside of the tank space to the tank space along the main flow path. One end in the extension direction of the sub flow path is located adjacent to one closed end of the ends in the extension direction of the main flow path, so that the refrigerant flowing through the sub flow path may enter the main flow path. The refrigerant entering the main flow path may flow toward the outside of the tank space and may be heat-exchanged with purified water.

Therefore, while the pressure of the refrigerant flowing through the sub flow path drops, an increase in enthalpy can be minimized. Furthermore, the main flow path through which the refrigerant flows may be directly heat-exchanged with purified water. Accordingly, the cooling efficiency of purified water by the refrigerant can be improved.

In addition, according to the above configuration, the cold water tank assembly according to an exemplary embodiment of the present invention can minimize the number of communication points with the outside.

The refrigerant flow path part penetrates the tank base of the tank part and extends in the tank space. In this case, the refrigerant flow path part includes a sub flow path that forms a flow path of an introduced refrigerant and is accommodated in the main flow path, a main flow path forming a flow path of the refrigerant flowing out, and a branch flow path that supports the sub flow path and the main flow path.

The branch flow path supports the main flow path and communicates with the main flow path. The refrigerant flowing along the main flow path and heat-exchanged with purified water may flow out through the branch flow path. The branch flow path supports the sub flow path, but communication with the sub flow path is blocked. One end of the sub flow path is exposed to the outside of the branch flow path, and the refrigerant to be heat-exchanged with purified water may be introduced into the sub hollow through the end of the sub flow path.

That is, the sub flow path forming the inlet flow path is formed in the main Flow path, and the sub flow path and the main flow path may be supported by a single branch flow path. Therefore, the refrigerant flow path part can be coupled to the tank part simply by penetrating the main flow path through the tank base at a single point.

Accordingly, the number of coupling positions between the refrigerant flow path part and the tank part can be minimized.

In addition, according to the above configuration, in the cold water tank assembly according to an exemplary embodiment of the present invention, an increase in temperature of the refrigerant can be minimized.

As described above, the refrigerant to be heat exchanged with purified water flows along the sub flow path. The sub flow path is accommodated in the main flow path through which the refrigerant heat-exchanged with purified water flows, and only one end in the extension direction thereof is exposed to the outside of the branch flow path.

The sub flow path and the refrigerant introduced into the sub flow path are not arbitrarily exposed to the outside until they are discharged to the outside through the branch flow path. That is, the area of the part where the component through which the refrigerant flows is exposed to the outside of the tank part is minimized.

In addition, the refrigerant flowing along the sub flow path is introduced from the inside of the tank space into the main flow path, flows in the direction of outflow to the outside of the tank space, and exchanges heat with purified water. Therefore, the pressure before the refrigerant is heat-exchanged with purified water can be sufficiently dropped, and an increase in enthalpy can be minimized.

Therefore, an increase in the temperature of the refrigerant due to arbitrary heat exchange with outside air or the like other than purified water can be prevented. As a result, the heat exchange efficiency between the refrigerant and the purified water is improved, and the cooling efficiency of the purified water can be improved.

In addition, according to the above configuration, the cold water tank assembly according to an exemplary embodiment of the present invention can be miniaturized in size.

As described above, the refrigerant flow path part is coupled to the tank part, specifically the tank base, at a single point. The sub flow path forming an inlet flow path of a refrigerant of the refrigerant flow path part is accommodated in the main flow path forming an outlet flow path of the refrigerant. Portions of the sub flow path and the main flow path exposed to the outside of the tank part are supported by the branch flow path.

Therefore, a change in the structure or the number of components required to couple the refrigerant flow path part to the tank part can be minimized. Accordingly, the size of the cold water tank assembly and the water purifier having the same can be reduced.

In addition, according to the above configuration, in the cold water tank assembly according to an exemplary embodiment of the present invention, water can be cooled for a sufficient time.

The flow path forming part is provided in the tank space. The flow path forming part includes membrane members that partition the tank space into a plurality of small spaces communicating with each other. The small spaces positioned adjacent to each other among the plurality of partitioned small spaces communicate at different ends along the longitudinal direction thereof.

That is, a zigzag flow path is formed inside the tank space by the flow path forming part. Purified water introduced into the tank space should flow in one direction in the longitudinal direction of one membrane member and then in the other direction in the longitudinal direction of another membrane member, so that it can flow toward the water outlet portion.

Therefore, the length of the flow path through which the purified water flows inside the tank part is increased, so that the heat exchange time with the refrigerant can also be increased. Accordingly, the purified water can be cooled for a sufficient time.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a perspective view illustrating a cold water tank assembly according to an exemplary embodiment of the present invention.

FIG. 2 is a perspective view from another angle, illustrating the cold water tank assembly of FIG. 1.

FIG. 3 is a side cross-sectional view illustrating the configuration of the cold water tank assembly of FIG. 1.

FIG. 4 is a side cross-sectional view illustrating the configuration of the cold water tank assembly of FIG. 1.

FIG. 5 is a front cross-sectional view illustrating the configuration of the cold water tank assembly of FIG. 1.

FIG. 6 is an exploded perspective view illustrating the configuration of the cold water tank assembly of FIG. 1.

FIG. 7 is a perspective view illustrating a flow path forming part and a refrigerant flow path part provided in the cold water tank assembly of FIG. 1.

FIG. 8 is a front view illustrating the flow path forming part of FIG. 7.

FIG. 9 is a side view illustrating the flow path forming part of FIG. 7.

FIG. 10 is a side view illustrating a modified example of the flow path forming part of FIG. 7.

FIG. 11 is a front view illustrating the refrigerant flow path part of FIG. 7.

FIG. 12 is a side view illustrating the refrigerant flow path part of FIG. 7.

FIG. 13 is an exploded perspective view illustrating the configuration of the refrigerant flow path part of FIG. 7.

FIG. 14 is a partially cut-away perspective view illustrating the refrigerant flow path part of FIG. 7.

FIG. 15 is a side cross-sectional view illustrating the refrigerant flow path part of FIG. 7.

FIG. 16 is a side cross-sectional vier illustrating a flow path of a refrigerant formed inside a cold water tank assembly according to an exemplary embodiment of the present invention.

FIG. 17 is a side cross-sectional view illustrating a flow path of cold water formed inside a cold water tank assembly according to an exemplary embodiment of the present invention.

### DETAILED DESCRIPTION OF THE EMBODIMENTS

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

In the following description, in order to clarify the features of the present invention, descriptions of some components may be omitted.

The term “communication” used in the following description means that one or more members are connected to each other so as to be in fluid communication. In an embodiment, the communication may be formed by a member such as a conduit, a pipe, a tubing, or the like.

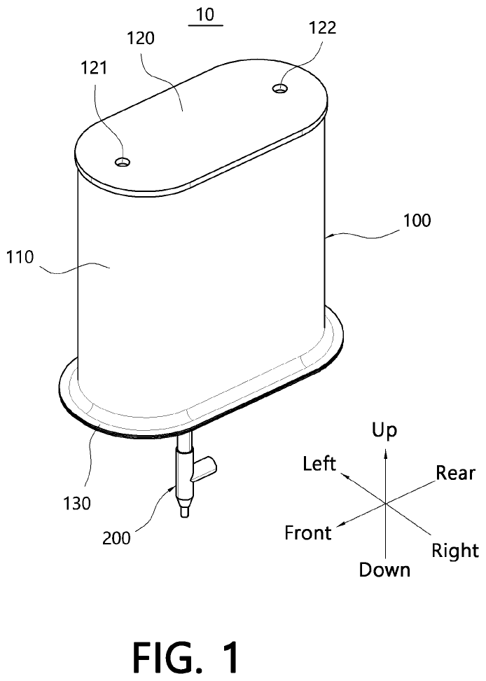

The terms “above or upper side”, “below or lower side”, “left side”, “right side”, “front side”, and “rear side” used in the following description will be understood with reference to the coordinate system shown in the accompanying FIG. 1.

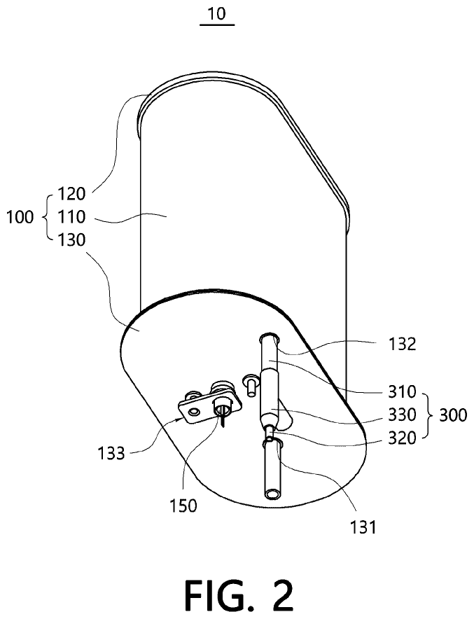

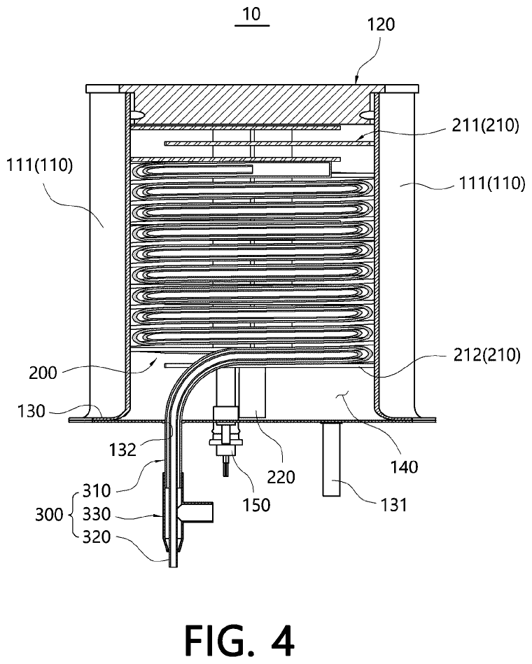

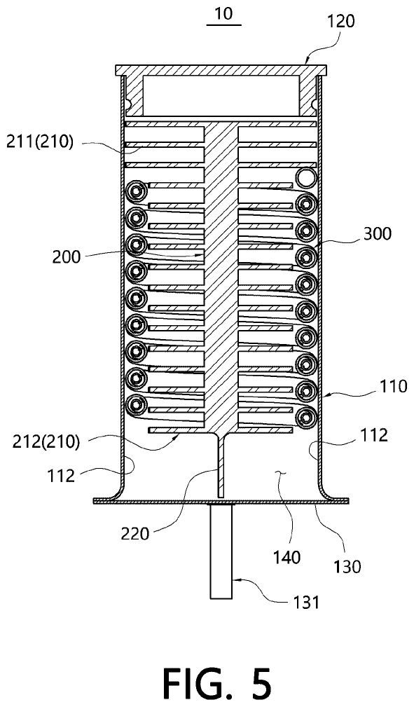

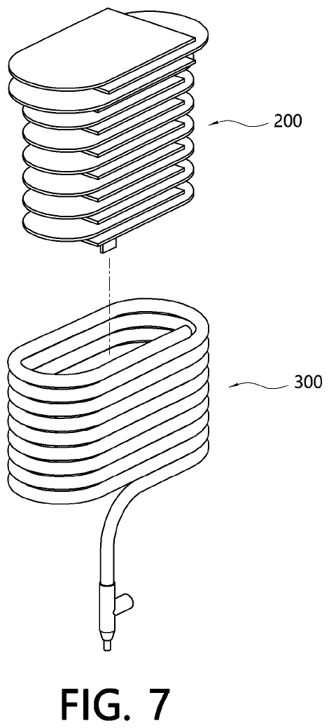

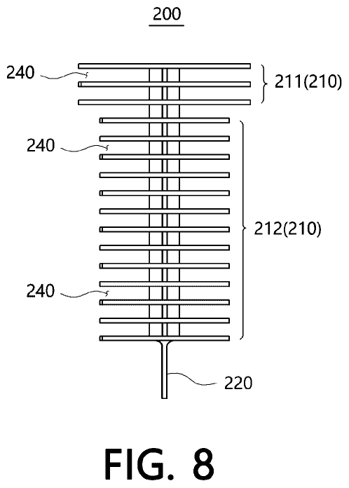

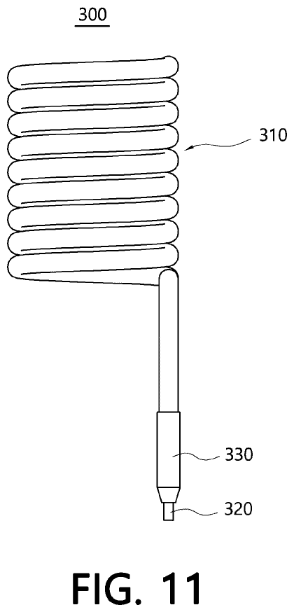

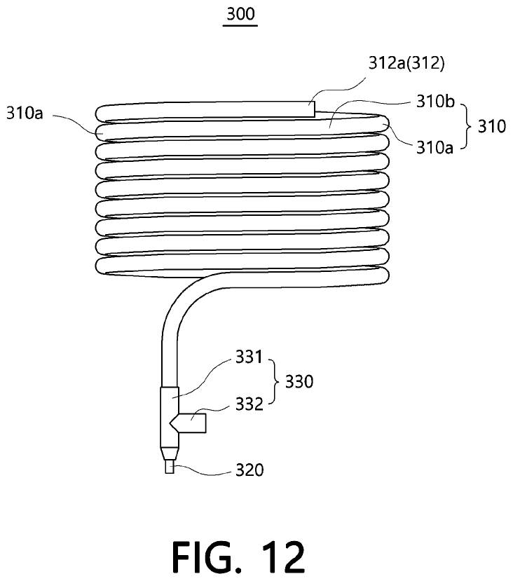

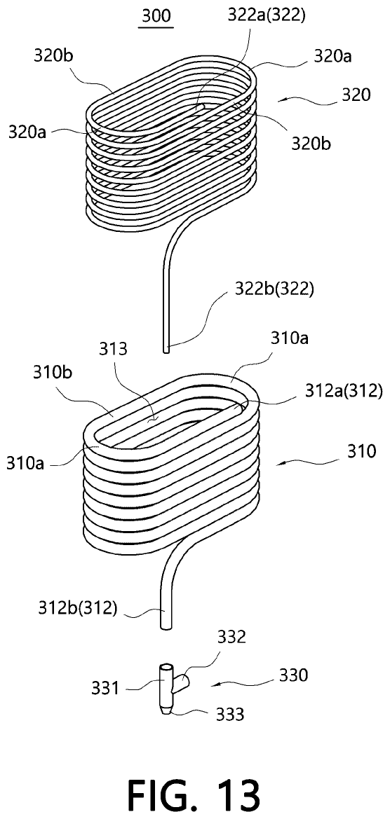

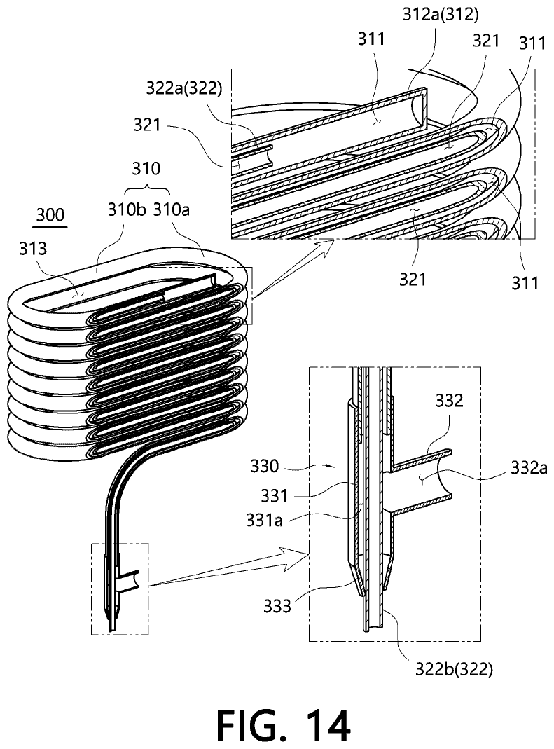

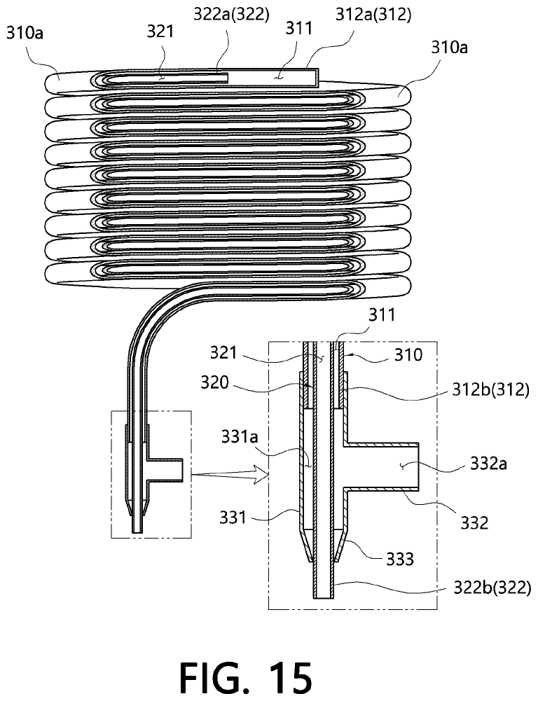

Referring to FIGS. 1 to 15, a cold water tank assembly 10 according to an exemplary embodiment of the present invention is illustrated. In the cold, water tank assembly 10 according to an exemplary embodiment of the present invention, a flow path through which a refrigerant flows is formed inside a tank part 100 in which water is stored. Accordingly, since the purified water flowing in the tank part 100 is directly heat-exchanged with the refrigerant flowing through the flow path, the cooling efficiency of the purified water may be improved.

In this case, the flow path through which the refrigerant flows communicates with the outside at a single point. Therefore, the number of points heat-exchanged with the outside before a refrigerant flows into the cold water tank assembly 10 is also reduced to one, thereby minimizing the increase in the temperature of the refrigerant. Accordingly, the heat exchange efficiency between the refrigerant and the purified water is improved, and the cooling efficiency of the purified water may be improved.

Furthermore, since the flow path through which the refrigerant flows is combined with the tank part 100 at the minimum point, arbitrary outflow of purified water or cold water flowing into the tank part 100 may be prevented. As a result, the size of the cold water tank assembly 10 and the entire water purifier including the same may be reduced.

The cold water tank assembly 10 according to an exemplary embodiment of the present invention, which will be described below, is described on the premise that it is provided in a water stream type water purifier. Alternatively, it will be understood that the cold water tank assembly 10 according to an exemplary embodiment of the present invention may also be applied to a water purifier having a separate storage tank for storing purified water or cold water.

In the illustrated embodiment, the cold water tank assembly 10 includes a tank part 100, a flow path forming part 200, and a refrigerant flow path part 300.

In the following description, it is assumed that the flow path forming part 200 is provided in the cold water tank assembly 10. Alternatively, in another embodiment, the flow path forming part 200 may be selectively provided.

That is, the tank part 100 is not limited to the configuration to be described later, and may be provided in a form of being cooled by the refrigerant flowing through the refrigerant flow path while filled with cold water therein. Alternatively, the tank part 100 may be a cold water tank in which a refrigerant is filled and cold water flows through a separate cold water flow path.

In the above embodiment, it will be understood that the effect of the cold water tank assembly 10 according to an exemplary embodiment of the present invention can be achieved even if the flow path forming part 200 is not separately provided.

The tank part 100 forms the outer shape of the cold water tank assembly 10. The tank part 100 may communicate with the outside to receive filtered purified water. Although not shown, the tank part 100 may communicate with a filter member provided in the water purifier to receive filtered purified water while passing through the filter member.

A space is formed inside the tank part 100. Introduced purified water may flow in the space of the tank part 100. In this case, the flow path forming part 200 for forming a flow path through which introduced purified water flows may be disposed in the space. In addition, the refrigerant flow path part 300, which is a flow path of refrigerant that exchanges heat with purified water flowing along the flow path formed by the flow path forming part 200, may be accommodated in the space above.

As will be described later, the number of communication points with the outside may be minimized in the space of the tank part 100. Specifically, the refrigerant flow path part 300 accommodated in the space of the tank part 100 communicates with the outside at a single point. Accordingly, the structure of the tank part 100 is simplified, and an arbitrary temperature increase of the refrigerant is prevented, thereby improving cooling efficiency.

In the embodiments shown in FIGS. 1 to 6, the tank part 100 includes a tank body 110, a tank cover 120, a tank base 130, a tank space 140, and a sensor member 150.

The tank body 110 forms a part of the outer shape of the tank part 100. In the illustrated embodiment, the tank body 110 forms the radial direction of the tank part 100, that is, the front side, the rear side, the left side, and the right side.

The tank body 110 is formed to have a height in one direction, that is, in the up-down direction in the illustrated embodiment. One side and the other side in the height direction of the tank body 110, that is, the upper side and the lower side in the illustrated embodiment, are formed open. Purified water may be introduced into the tank body 110 through the one side of the tank body 110, that is, the upper side. The cooled purified water, that is, cold water, may flow out of the tank body 110 through the other side, that is, the lower side of the tank body 110.

The tank body 110 is coupled to the tank cover 120. The one side in the height direction of the tank body 110, that is, the upper side, may be closed by the tank cover 120.

The tank body 110 is coupled to the tank base 130. The other side in the height direction of the tank body 110, that is, the lower side, may be closed by the tank base 130.

A space (i.e., a tank space 140 to be described later) is formed inside the tank body 110. The flow path forming part 200 may be accommodated in the space of the tank body 110 to form a flow path through which purified water is introduced and flows. In addition, the refrigerant flow path part 300 may be accommodated in the space of the tank body 110 to cool the flowing purified water.

The tank body 110 may have an arbitrary shape in which a tank space 140 is formed therein to communicate with the outside, and may communicate with the tank cover 120 and the tank base 130, respectively. In the illustrated embodiment, the tank body 110 is a three-dimensional figure shape having an outer circumference formed by a pair of straight lines facing each other and a pair of curves facing each other that are continuous with the pair of straight lines, and having a height in the up-down direction.

In the illustrated embodiment, the tank body 110 includes a first inner wall 111 and a second imer wall 112.

The first inner wall 111 forms a part of the tank body 110. The first inner wall 111 partially surrounds the tank space 140. The first inner wall 111 is formed to extend in the height direction of the tank body 110, that is, in the up-down direction in the illustrated embodiment.

The first inner wall 111 is provided in the plural number and the plurality of first inner walls 111 may surround the tank space 140 at a plurality of points. In the illustrated embodiment, the first inner wall 111 is provided in a pair to form a front side and a rear side of the tank body 110. The pair of first inner walls 111 are disposed to face each other with the tank space 140 interposed therebetween.

The first inner wall 111 may be formed in an arbitrary shape, forming part of the tank body 110 and partially surrounding the tank space 140. In the illustrated embodiment, the first inner wall 111 has a curved shape that is rounded and convex toward the outside and that has a height in the up-down direction.

The first inner wall 111 is positioned adjacent to a first end 210a of the flow path forming part 200 accommodated in the tank space 140. In addition, the first inner wall 111 is located adjacent to a first main extension 310a and a first sub extension 320a of the refrigerant flow path part 300.

The first inner wall 111 is continuous with the second inner wall 112. In the illustrated embodiment, each end of the first inner wall 111 in the width direction, that is, in the left-right direction, is continuous with the second inner wall 112.

The second inner wall 112 forms another part of the tank body 110. The second inner wall 112 surrounds another part of the tank space 140. The second inner wall 112 is formed to extend in the height direction of the tank body 110, that is, in the up-down direction in the illustrated embodiment.

The second inner wall 112 is provided in the plural number and the plurality of second inner walls 112 may surround the tank space 140 at a plurality of points. In the illustrated embodiment, the second inner wall 112 is provided in a pair to form a left side and a right side of the tank body 110. The pair of second inner walls 112 are disposed to face each other with the tank space 140 interposed therebetween.

The second inner wall 112 may be formed in an arbitrary shape, forming another part of the tank body 110 and partially surrounding the tank space 140. In the illustrated embodiment, the second inner wall 112 has a planar shape having a length in the front-rear direction and a height in the up-down direction.

The second inner wall 112 is located adjacent to a second main extension 310b and a second sub extension 320b of the refrigerant flow path part 300.

Each end in the height direction of the first inner wall 111 and the second inner wall 112 is coupled to the tank cover 120 and the tank base 130, respectively.

The tank cover 120 forms one side in the height direction of the tank part 100, that is, the upper side in the illustrated embodiment. The tank cover 120 covers the tank space 140 and is coupled to the tank body 110. Any communication between the tank space 140 and the outside may be blocked by the tank cover 120.

The tank cover 120 may have any shape coupled to the tank body 110 to close the one side of the tank space 140, that is, the upper side in the illustrated embodiment. In the illustrated embodiment, the tank cover 120 is formed to have a cross-section having a pair of straight lines facing each other and a pair of curves continuous with the pair of straight lines and facing each other. The shape of the tank cover 120 may be changed according to the shape of the tank body 110.

In the illustrated embodiment, the tank cover 120 includes a water inlet portion 121 and a gas communication portion 122.

The water inlet portion 121 is through-coupled to the tank cover 120 to communicate the tank space 140 with the outside. The filtered purified water may be introduced into the tank space 140 through the water inlet portion 121.

The water inlet portion 121 may be positioned to be biased toward one side in the longitudinal direction of the tank cover 120, that is, in the front-rear direction in the illustrated embodiment. In the illustrated embodiment, the water inlet portion 121 is positioned to be biased toward the front side of the tank cover 120.

In this case, the water inlet portion 121 may be formed at an arbitrary position capable of forming a passage through which purified water flows into the tank space 140 by communicating with the outside and tank space 140, respectively. In an embodiment, the water inlet portion 121 may be formed on the tank base 130.

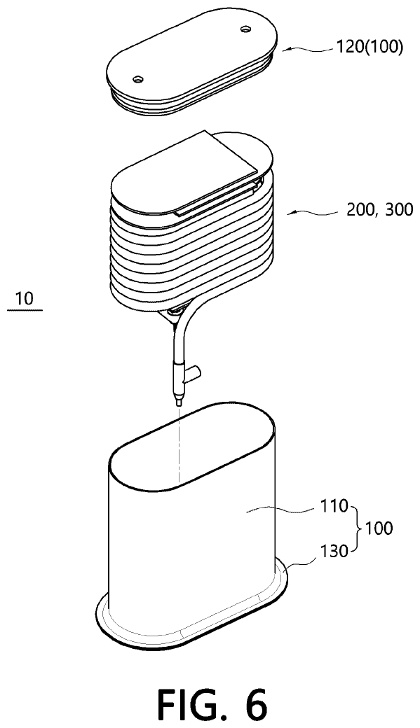

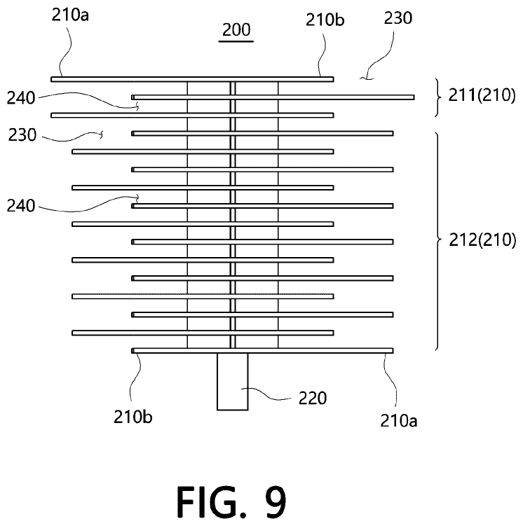

The position of the water inlet portion 121 may be determined according to the position of the closest membrane member 210 among membrane members 210 provided in the flow path forming part 200, that is, the position of a first end 210a located at the uppermost side of the membrane member 210 (see FIGS. 6 and 9).

That is, as will be described later, the purified water introduced into the tank space 140 cannot enter the flow space 230 through the first end 210a. The purified water may enter the flow space 230 only after progressing to a second end 210b of the membrane member 210. In this case, the purified water flows from the first end 210a toward the second end 210b and may be cooled by heat exchange with the refrigerant.

Accordingly, the water inlet portion 121 is biased toward the first end 210a, so that the purified water flowing into the tank space 140 may flow to the membrane member 210 located on the second-uppermost side only after flowing to the second end 210b along the membrane member 210 located on the uppermost side.

Accordingly, the heat exchange time between the purified water and the refrigerant is increased, and thus the cooling efficiency of the purified water may be improved.

The gas communication portion 122 is formed through the tank cover 120 to communicate the tank space 140 with the outside. A gas remaining in the tank space 140 may be discharged to the outside of the tank space 140 through the gas communication portion 122. In addition, when cooled water flows out, external gas may enter the tank space 140 through the gas communication portion 122. Accordingly, the outflow of cooled water may proceed smoothly.

The gas commmication portion 122 may be positioned to be biased toward the other side in the longitudinal direction of the tank cover 120, that is, in the front-rear direction in the illustrated embodiment. In the illustrated embodiment, the gas communication portion 122 is positioned to be biased toward the rear side of the tank cover 120.

The position of the gas communication portion 122 may be determined according to the position of the water inlet portion 121. That is, the gas communication portion 122 may be positioned opposite to the water inlet portion 121. Accordingly, the passage through which the purified water flows into the tank space 140, that is, the water inlet portion 121, and the passage through which the air remaining in the tank space 140 or outside air flows, that is, the gas communication portion 122, are space apart, so that any outflow of the introduced purified water may be prevented.

Although not shown, a fitting may be provided in the water inlet portion 121 and the gas communication portion 122. The fitting may be coupled to the water inlet portion 121 and the gas communication portion 122, respectively, and may be coupled to and communicated with other external devices.

The tank base 130 forms the other side in the height direction of the tank part 100, that is, the lower side in the illustrated embodiment. The tank base 130 covers the tank space 140 and is coupled to the tank body 110. Any communication between the tank space 140 and the outside may be blocked by the tank base 130.

The tank base 130 may have any shape coupled to the tank body 110 to close the other side of the tank space 140, that is, the lower side in the illustrated embodiment. In the illustrated embodiment, the tank base 130 is formed to have a cross-section having a pair of straight lines facing each other and a pair of curves continuous with the pair of straight lines and facing each other.

It will be understood that the shape of the tank base 130 is similar to the shape of the tank cover 120. The shape of the tank base 130 may be changed according to the shape of the tank body 110.

In the illustrated embodiment, the tank base 130 includes a water outlet portion 131, a flow path through portion 132, and a sensor coupling portion 133.

The water outlet portion 131 is formed through the tank base 130 to communicate the tank space 140 with the outside. Purified water flowing and cooled in the tank space 140, that is, cold water, may flow out of the tank space 140 through the water outlet portion 131.

The water outlet portion 131 may be positioned to be biased toward one side in the longitudinal direction of the tank base 130, that is, in the front-rear direction in the illustrated embodiment. In the illustrated embodiment, the water outlet portion 181 is positioned to be biased toward the rear side of the tank base 130.

The position of the water outlet portion 131 may be determined according to the position of the closest membrane member 210 among membrane members 210 provided in the flow path forming part 200, that is, the position of the first end 210a located at the lowermost side of the membrane member 210 (see FIGS. 6 and 9).

In this case, the water outlet portion 131 may be formed at an arbitrary position capable of forming a passage through which generated cold water flows out from the tank space 140 to the outside by communicating with the outside and tank space 140, respectively. In an embodiment, the water outlet portion 131 may be formed on the tank cover 120.

That is, as will be described later, the purified water flowing and cooled along the flow path forming part 200 falls toward the tank base 130 through a flow space 230 adjacent to the second end 210b of the membrane member 210 located at the lowermost side. In this case, the water outlet portion 131 is positioned opposite to the second end 210b, so that the cold water falling from the second end 210b of the lowermost membrane member 210 may flow in the longitudinal direction of the tank base 130, that is, the front and rear direction, and then enter the water outlet portion 131.

Therefore, the cold water passing through the flow path forming part 200 is prevented from directly falling on the water outlet portion 131, and the outflow flow rate of the cold water can be easily adjusted.

In the illustrated embodiment, the water outlet portion 131 includes a water outlet through hote 131a.

The water outlet through hole 131a is a hollow formed to be coupled to the inside of a fitting coupled to the water outlet portion 131. The water outlet through hole 131a extends in the extension direction of the fitting, that is, in the up-down direction in the illustrated embodiment. Each end in the extension direction of the water outlet through hole 131a, that is, the upper end and the lower end in the illustrated embodiment, is formed open to communicate the tank space 140 with the outside, respectively.

The flow path through portion 132 is formed through the tank base 130 to form a passage through which the refrigerant flow path part 300 extends into the tank space 140. The refrigerant flow path part 300 may extend from the outside to the tank space 140 by penetrating the flow path through portion 132.

The flow path through portion 132 may be positioned to be biased toward the other side in the longitudinal direction of the tank base 130, that is, in the front-rear direction in the illustrated embodiment. In the illustrated embodiment, the flow path through portion 132 is positioned to be biased toward the front side of the tank base 130.

The position of the flow path through portion 132 may be determined according to the position of the water outlet portion 131. That is, the flow path through portion 132 may be positioned opposite to the water outlet portion 131. Accordingly, a passage through which the generated cold water flows out of the tank space 140, that is, the water outlet portion 131 and the refrigerant flow path part 300 extending into the tank space 140 are spaced apart, so that the flow of cold water may be made smoothly.

In this case, the flow path through portion 132 may be formed at an arbitrary position capable of forming a passage through which the refrigerant flow path part 300 is penetrated by communicating with the outside and tank space 140, respectively. In an embodiment, the flow path through portion 132 may be formed on the tank cover 120.

The sensor coupling portion 133 is positioned between the water outlet portion 131 and the flow path through portion 132.

The sensor coupling portion 133 is a space to which the sensor member 150 is coupled. The sensor coupling portion 133 is configured to support the sensor member 150 through-coupled to the tank base 130.

The sensor coupling portion 133 is coupled to the tank base 130. The sensor coupling portion 133 may be positioned adjacent to a through hole (reference numeral not indicated) through which the sensor member 150 passes.

The tank space 140 is a space formed inside the tank body 110. The tank space 140 may communicate with the outside to allow filtered purified water to flow in. The communication is achieved by the water inlet portion 121. Purified water flowing and cooled in the tank space 140, that is, cold water, may flow out to the outside. The communication is achieved by the water outlet portion 131.

In the illustrated embodiment, purified water flows to the upper side of the tank space 140, flows to the lower side, cools, and flows out through the lower side of the tank space 140 to the outside. As described above, the direction in which purified water flows into the tank space 110 may be changed to the upper side or the lower side of the tank space 140. Likewise, the direction in which cold water flows out of the tank space 140 may also be changed to the upper side or the lower side of the tank space 140.

In this case, as described above, the water inlet portion 121 and the water outlet portion 131 may be formed on the tank cover 120 or the tank base 130 corresponding to the inflow direction of purified water and the outflow direction of cold water.

The flom path forming part 200 is accommodated in the tank space 140. The tank space 140 may be partitioned into a plurality of small spaces communicating with each other by the flow path forming part 200. In this case, the plurality of partitioned small spaces are alternately commmicated by each end of the membrane member 210 in the longitudinal direction of the flow path forming part 200. Accordingly, the introduced purified water may sufficiently flow and be cooled.

The refrigerant flow path part 300 is partially accommodated in the tank space 140. The refrigerant flow path part 300 may extend while surrounding the flow path forming part 200 accommodated in the tank space 140, and one end of which may be exposed to the outside so that the refrigerant may flow in and out. Purified water flowing through the plurality of small spaces may be cooled by exchanging heat with the refrigerant flowing in the refrigerant flow path part 300.

The tank space 140 is defined surrounded by the tank body 110, the tank cover 120, and the tank base 130. In the illustrated embodiment, the radial direction of the tank space 140 is surrounded by the tank body 110, and the upper side and the lower side of the tank space 140 are surrounded by the tank cover 120 and the tank base 130, respectively.

The tank space 140 may have a shape corresponding to the tank body 110, the tank cover 120, and the tank base 130. In the illustrated embodiment, the tank space 140 is formed as a space with a height in the up-down direction, having a shape of a cross-section of the tank body 110, that is, a cross-section having a pair of curves and a pair of straight lines.

The sensor member 150 is configured to detect information on purified water or cold water flowing in the tank space 140. In an embodiment, the sensor member 150 may detect pressure, temperature, or flow rate or the like of the tank space 140.

The sensor member 150 is coupled to the tank base 130. The sensor member 150 penetrates the tank base 130 and extends to the tank space 140. The sensor member 150 is supported by the sensor coupling portion 133.

The sensor member 150 may be provided in an arbitrary form capable of detecting information on purified water or cold water flowing in the tank space 140. In an embodiment, the sensor member 150 may be provided as a pressure sensor, a temperature sensor, or a flow sensor.

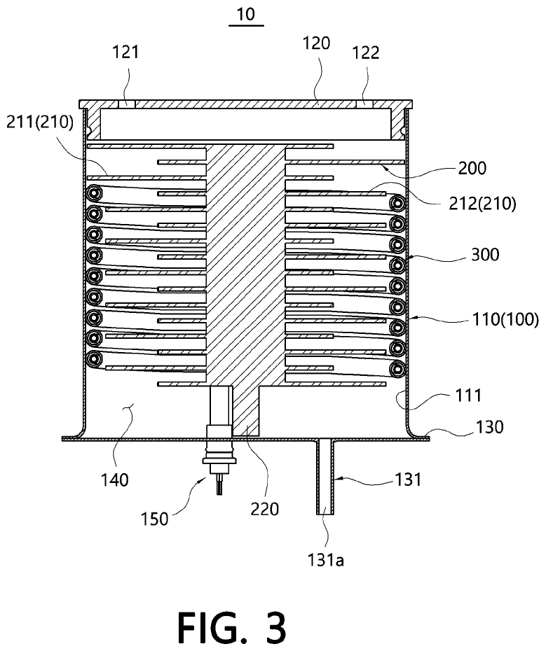

Referring back to FIGS. 3 to 10, the cold water tank assembly 10 according to an exemplary embodiment of the present invention includes a flow path forming part 200.

The flow path forming part 200 forms a flow path through which purified water introduced into the tank space 140 flows. By the flow path forming part 200, purified water may be sufficiently heat-exchanged with the refrigerant, and may be cooled and then discharged. The flow path forming part 200 is accommodated in the tank space 140. The flow path forming part 200 partitions the tank space 140 into a plurality of small spaces.

The plurality of partitioned small spaces alternately communicate with adjacent small spaces through different ends along the extension direction thereof. That is, purified water flowing in any one partitioned small space may flow along one direction in the longitudinal direction of the small space, enter an adjacent small space, and then flows along the other direction in the longitudinal direction thereof, and then enter another small space.

The flow path forming part 200 is disposed to be surrounded by the tank body 110. In the illustrated embodiment, the flow path forming part 200 is disposed adjacent to the pair of first inner walls 111 and the pair of second inner walls 112.

The flow path forming part 200 is disposed to be surrounded by the refrigerant flow path part 300. In the illustrated embodiment, the flow path forming part 200 is accommodated in an accommodation space 313 in which a main flow path 310 is formed to extend in a spiral shape. Therefore, purified water flowing in the plurality of small spaces partitioned by the flow path forming part 200 may be heat-exchanged with a refrigerant flowing in the refrigerant flow path part 300.

In the illustrated embodiment, the flow path forming part 200 includes a membrane member 210, a column member 220, a flow space 230, and a separation space 240.

The membrane member 210 partitions the tank space 140 into a plurality of small spaces. The purified water introduced into the tank space 140 may flow and be cooled in the plurality of small spaces along the membrane member 210.

The membrane member 210 may be formed of a flexible material. The membrane member 210 may be deformed in shape, store a restoring force, be accommodated in the tank space 140, and may be restored to its original shape by the restoring force.

The membrane member 210 may be formed to correspond to the shape of the flat cross-section of the tank space 140. In the illustrated embodiment, the tank space 140 is formed to have a length in the front-rear direction and a width in the left-right direction. Accordingly, the membrane member 210 may also be formed to have a length in the front-rear direction and a width in the left right direction.

In this case, the length (i.e., the length in the front-rear direction) and the width (i.e., the width in the left-right direction) of the membrane member 210 may be formed to be less than or equal to the length and width of the tank space 140. Accordingly, the membrane member 210 may be disposed to be partially surrounded by the refrigerant flow path part 300.

In this case, each end in the longitudinal direction of the membrane member 210, that is, one end of the front end and the rear end in the illustrated embodiment may be defined as a first end 210a, and the other end may be defined as a second end 210b. The first end 210a and the second end 210b are positioned between the pair of first inner walls 111.

Specifically, one end of the longitudinal ends of the membrane member 210 disposed closer to the first inner wall 111 or the refrigerant flow path part 300 is defined as the first end 210a. In addition, the other end of the longitudinal ends of the membrane member 210 that is placed relatively spaced apart from the first inner wall 111 or the refrigerant flow path part 300 is defined as the second end 210b.

Therefore, purified water flowing along the membrane member 210 may flow toward another membrane member 210 through a space (a flow space 230 to be described later) between the second end 210b and the first inner wall 111 or the refrigerant flow path part 300.

In addition, in an embodiment, the width of the membrane member 210 may be formed equal to the width of the tank space 140. In the above embodiment, an edge in the width direction of the membrane member 210 may be in close contact with the second inner wall 112 to prevent inflow of purified water. Therefore, purified water may flow from one separation space 240 to another separation space 240 only through the flow space 230.

The membrane member 210 may be provided in the plural number. The plurality of membrane members 210 may be disposed to be spaced apart from each other to partition the tank space 140 into a plurality of small spaces in the height direction thereof. In the illustrated embodiment, the plurality of membrane members 210 are disposed to be spaced apart from each other in the up-down direction. In other words, the plurality of membrane members 210 are stacked in the height direction of the tank space 140.

In this case, one group of membrane members 210 positioned biased toward the tank cover 120 among the plurality of membrane members 210 and the other group of membrane members 210 may have different extension lengths.

That is, as shown in FIG. 9, the plurality of membrane members 210 may be divided into a first membrane member 211 positioned at a relatively upper side and a second membrane member 212 positioned at a relatively lower side.

The first membrane member 211 is positioned to be biased toward the tank cover 120 to form an upstream side of a flow path through which purified water introduced through the water inlet portion 121 flows in the tank space 140. The second membrane member 212 is positioned to be biased toward the tank cover 120 to form a downstream side of a flow path of cold water cooled while flowing.

In this case, the first membrane member 211 may be extended by a longer length than the second membrane member 212. Accordingly, the first end 210a of the first membrane member 211 may be disposed closer to the first inner wall 111 than the second end 210b of the second membrane member 212 (see FIG. 3). This is to induce purified water to flow only through a preset flow path since the purified water flows before heat exchange with a refrigerant in the first membrane member 211.

That is, in the illustrated embodiment, the first membrane member 211 is located above the main flow path 310 of the refrigerant flow path part 300. That is, only purified water flowing along the first membrane member 211 may be heat-exchanged with the refrigerant flow path part 300.

Therefore, arbitrary mixing of purified water that has just flowed into the tank space 140 and has a relatively high temperature and cold water cooled by heat exchange with a refrigerant can be prevented. As a result, the cooling efficiency of the purified water may be improved.

The number of first membrane members 211 and the number of second membrane members 212 may be changed. In an embodiment shown in FIG. 9, three first membrane members 211 and thirteen second membrane members 212 are provided.

In this case, as described above, the first end 210a of the first membrane member 211 is located adjacent to the first inner wall 111. In an embodiment, the first end 210a of the first membrane member 211 may be in close contact with the first inner wall 111. In the above embodiment, the newly introduced purified water (i.e., purified water before cooling) is not introduced between the first end 210a of the first membrane member 211 and the first inner wall 111.

In the embodiments shown in FIGS. 3 to 9, the First membrane member 211 and the second membrane member 212 extend horizontally. Therefore, in the above embodiment, the purified water introduced into the tank space 140 may flow while being pushed by the purified water introduced through the water inlet portion 121.

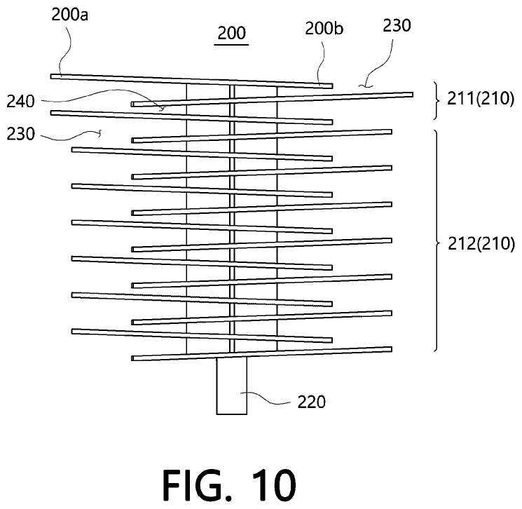

Alternatively, in the embodiment shown in FIG. 10, the first membrane member 211 and the second membrane member 212 may extend obliquely with respect to the horizontal direction. In this case, the first membrane member 211 and the second membrane member 212 may extend such that the height of the first end 210a is higher than the height of the second end 210b. That is, the first membrane member 211 and the second membrane member 212 may extend obliquely domward in a direction toward the second end 210b.

In the above embodiment, the purified water introduced into the tank space 140 may also flow by gravity along the first membrane member 211 and the second membrane member 212 which extend obliquely.

The column member 220 supports the plurality of membrane members 210. The plurality of membrane members 210 may be coupled to the column member 220, respectively. Accordingly, the plurality of membrane members 210 may be stably maintained in a state spaced apart from each other.

The colum member 220 is formed to extend in the height direction of the tank space 140, that is, in the up-down direction in the illustrated embodiment. One end in the extension direction of the column member 220, that is, the upper end in the illustrated embodiment, may be coupled to the tank cover 120. The other end in the extension direction of the column member 220, that is, the lower end in the illustrated embodiment, may be coupled to the tank base 130.

The column member 220 is formed to have a narrow width (that is, a length in the left right direction). This is to prevent the flow of purified water and cooled cold water introduced into the tank space 140 by the column member 220 from being disturbed.

A space formed by separating the second end 210b of the membrane member 210 from the first inner wall 111 is defined as a flow space 230.

The flow space 230 communicates a space formed between a pair of membrane members 210 adjacent to each other among the plurality of membrane members 210 (i.e., a separation space 240 to be described later). The purified water or cooled purified water flowing in one separation space 240 along the membrane member 210 may flow through the flow space 230 to another separation space 240.

In the illustrated embodiment, the plurality of separation spaces 240 are partitioned and stacked in the up-down direction with the membrane member 210 interposed therebetween. Accordingly, it may be said that the flow space 230 communicates the plurality of separation spaces 240 in the up-down direction.

The flow space 230 is formed between the second end 210b of the membrane member 210 and the first inner wall 111. The purified water flows from one side adjacent to the first end 210a toward the second end 210b along the membrane member 210 and then flows through the flow space 230 to another separation space 240.

The flow space 230 may be formed in the plural number. The flow spaces 230 may be formed between the second end 210b of the plurality of membrane members 210 and the first inner wall 111, respectively. In the illustrated embodiment, it will be understood that since sixteen membrane members 210 that are spaced apart from each other in the up-down direction are provided, sixteen flow spaces 230 are also formed.

The plurality of flow spaces 230 may be alternately disposed along the longitudinal direction of the membrane member 210. That is, as described. above, the second end 210b of the plurality of membrane members 210 is alternately disposed on the front and rear sides along a direction (i.e., up-down direction) in which the plurality of membrane members 210 are stacked.

Accordingly, the plurality of flow spaces 230 are also alternately formed on the front and rear sides along a direction in which the plurality of membrane members 210 are stacked. Purified water introduced into the tank space 140 may alternately pass through the flow space 230 on the front side and the flow space 230 on the rear side and flow toward the water outlet portion 131.

As a result, a zigzag-shaped purified water flow path is formed in the tank space 140 by the flow path forming part 200. Thus, the purified water may flow while exchanging heat with the refrigerant for a sufficient time. Accordingly, the cooling efficiency of the purified water may be improved.

A space in which the plurality of membrane members 210 are formed to be spaced apart from each other is defined as a separation space 240.

The separation space 240 is a space in which purified water flows between the membrane members 210. The separation space 240 is defined by partitioning the tank space 140 by the plurality of membrane members 210. That is, it will be understood that the plurality of small spaces described above refer to a plurality of separation spaces 240.

The separation space 240 is formed between the plurality of membrane members 210. In the illustrated embodiment, the upper and lower sides of the separation space 240 are partially surrounded by a pair of adjacent membrane members 210.

The separation space 240 may be formed in the plural number. Each of the plurality of separation spaces 240 may be formed between a pair of membrane members 210 positioned adjacent to each other among the plurality of membrane members 210. In the illustrated embodiment, a total of fifteen separation spaces 240 are formed between the sixteen membrane members 210.

A main flow path 310 and a sub flow path 320 of the refrigerant flow path part 300 may be partially accommodated in the plurality of separation spaces 240, respectively. Therefore, purified water flowing in the separation space 240 may be heat-exchanged with the refrigerant flowing in the refrigerant flow path part 300.

The plurality of separation spaces 240 communicate with each other. Specifically, one end of the plurality of separation spaces 240 that is blased toward the second end 210b communicates with the separation space 240 located on the upstream side, that is, the separation space 240 on the upper side in the illustrated embodiment. The communication is formed by the flow space 230.

The separation space 240 located at the uppermost side among the plurality of separation spaces 240 communicates with the water inlet portion 121 through the flow space 230. The separation space 240 located at the lowermost side among the plurality of separation spaces 240 communicates with the water outlet portion 131 through the flow space 230.

Accordingly, as described above, a zigzag-shaped purified water flow path is formed in the tank space 140.

Referring back to FIGS. 3 to 7 and FIGS. 11 to 15, the cold water tank assembly 10 according to an exemplary embodiment of the present invention includes a refrigerant flow path part 300.

The refrigerant flow path part 300 forms a flow path through which a refrigerant flows. The refrigerant flowing in the refrigerant flow path part 300 is configured to cool the purified water by exchanging heat with purified water flowing in the tank space 140.

The refrigerant flow path part 300 is partially accommodated in the tank space 140. The refrigerant flow path part 300 may be located adjacent to purified water flowing in the tank space 140. Therefore, the heat exchange efficiency between the purified water flowing in the tank space 140 and the refrigerant flowing in the refrigerant flow path part 300 may be improved.

The refrigerant flow path part 300 is coupled to the tank base 130 of the tank part 100. A part of the refrigerant flow path part 300 is exposed to the outside of the tank body 110. The refrigerant may be introduced into the refrigerant flow path part 300 through the part above. In addition, the refrigerant flowing in the refrigerant flow path part 300 and heat-exchanged with purified water may flow out of the tank part 100 and the refrigerant flow path part 300 through the part above.

In this case, the refrigerant flow path part 300 according to an exemplary embodiment of the present invention is coupled to the tank base 130 at a single point. Therefore, the part where the refrigerant flow path part 300 is exposed to the outside of the tank part 100 is minimized, thereby minimizing the temperature increase of the refrigerant flowing into the tank space 140. In addition, the tank part 100, that is, the tank base 130, may reliably seal the tank space 140.

In addition, in the refrigerant flow path part 300 according to an exemplary embodiment of the present invention, a flow path through which the introduced refrigerant flows and a flow path through which the refrigerant heat-exchanged with the purified water flows out are separately formed. Accordingly, an increase in enthalpy of the refrigerant is minimized, and thus the cooling efficiency of the purified water may be improved.

In the illustrated embodiment, the refrigerant flow path part 300 includes a main flow path 310, a sub flow path 320, and a branch flow path 330.

The main flow path 310 is a portion where the refrigerant flow path part 300 is accommodated in the tank space 140 and exposed. The main flow path 310 may cool the purified water by exchanging heat with purified water flowing in the tank space 140.

A refrigerant flow path is formed inside the main flow path 310. In this case, the refrigerant flowing inside the main flow path 310 flows in a direction of outflow from the tank space 140, that is, downward in the illustrated embodiment. In other words, the main flow path 310 forms an outlet flow path of the refrigerant.

Therefore, the refrigerant flowing inside the main flow path 310 has the lowest enthalpy on the upstream side of the purified water flowing into the tank space 140. As will be described later, the refrigerant supplied from the outside flows along the sub flow path 320, and then flows into the main flow path 310 from an end of the main flow path 310 located inside the tank space 140, that is, a position adjacent to the first main end 312a to be described later.

That is, the refrigerant flowing along the main flow path 310 flows in a direction from the inside of the tack space 140 toward the outside, that is, in a direction from the first main end 312a toward the second main end 312b. Therefore, the refrigerant just introduced into the main flow path 310 has a minimum enthalpy. Accordingly, cooling efficiency of purified water introduced into the tank space 140 may be improved.

The refrigerant flowing out along the main flow path 310 receives heat from purified water introduced into the tank space 140. In an embodiment, a refrigerant of a liquid phase or a mixed phase of liquid and gas flowing along the sub flow path 320 may be introduced into the main flow path 310 to exchange heat with purified water, and may be phase-transferred into a mixed phase of liquid and gas.

That is, the refrigerant flowing in the main flow path 310 has a larger enthalpy than the refrigerant flowing in the sub flow path 320.

In the above embodiment, it may be said that the main flow path 310 functions as an evaporator of a refrigerant.

The sub flow path 320 is accommodated inside the main flow path 310. The refrigerant flowing in the main flow path 310 may flow along the sub flow path 320 and then may be introduced into the main flow path 310. In this case, the refrigerant flowing along the main flow path 310, that is, the refrigerant flowing out, may flow radially outside the sub flow path 320.

The main flow path 310 is coupled to the tank part 100. Specifically, the main flow path 310 is coupled through the flow path through portion 132 of the tank base 130. A part of the main flow path 310, that is, a part positioned above the tank base 130 in the illustrated embodiment, is accommodated in the tank space 140. Another part of the main flow path 310, that is, another part positioned below the tank base 130 in the illustrated embodiment, is located outside the tank space 140.

The main flow path 310 is located adjacent to the tank body 110. Specifically, the main flow path 310 is located adjacent to the first inner wall 111 and the second inner wall 112 and extends along the first inner wall 111 and the second inner wall 112. In an embodiment, the main flow path 310 may be in contact with and coupled to the first inner wall 111 and the second inner wall 112.

The main flow path 310 is coupled to the flow path forming part 200. Specifically, the main flow path 310 extends while surrounding the flow path forming part 200. As described above, the main flow path 310 extends along the first inner wall 111 and the second inner wall 112, and thus the main flow path 310 is coupled to the flow path forming part 200 in a form of winding the flow path forming part 200 radially from the outside.

The sub flow path 320 is accommodated inside the main flow path 310. The sub flow path 320 may extend along the main flow path 310. The main flow path 310 communicates with the sub flow path 320. The refrigerant flowing in the sub flow path 320 may be introduced into other parts of the main flow path 310 except for a portion in which the sub flow path 320 is accommodated.

The main flow path 310 is coupled to and communicates with the branch flow path 330. The direction discharged from the tank space 140 along the main flow path 310, that is, the refrigerant flowing downward in the illustrated embodiment, may be discharged to the outside through the branch flow path 330. In the illustrated embodiment, an outer end of the main flow path 310 (i.e., a second main end 312b to be described below) is coupled to and communicates with the branch flow path 330.

The main flow path 310 may be formed of a material having high thermal conductivity. This is to improve heat exchange efficiency between the purified water flowing outside the main flow path 310 and the refrigerant flowing inside the main flow path 310.

The main flow path 310 may be formed of a corrosion-resistant material. This is to prevent contamination of the purified water by the main flow path 310 since the main flow path 310 may be in contact with purified water flowing in the tank space 140.

In an embodiment, the main flow path 310 may be formed of a stainless steel (SUS) material.

The main flow path 310 extends between the inside and the outside of the tank part 100. That is, one end in the extension direction of the main flow path 310, that is, the upper end in the illustrated embodiment (i.e., the first main end 312a to be described later), is located inside the tank space 140. The other end in the extension direction of the main flow path 310, that is, the lower end in the illustrated embodiment (i.e., the second main end 312b to be described later), is located outside the tank space 140.

The main flow path 310 may have an arbitrary shape in which a hollow is formed therein to allow a refrigerant to flow and which may accommodate the sub flow path 320. In the illustrated embodiment, the main flow path 310 is formed in a tube shape.

The main flow path 310 may be divided into a plurality of portions. Some portions of the plurality of portions may be positioned adjacent to the first inner wall 111 and extend along the first inner wall 111. Another some portions of the plurality of portions may be positioned adjacent to the second inner wall 112 and extend along the second inner wall 112.

In the illustrated embodiment, the main flow path 310 may be divided into a first main extension 310a extending along the first inner wall 111 and a second main extension 310b extending along the second inner wall 112.

The first main extension 310a extends straight and is positioned adjacent to the first inner wall 111. The second main extension 310b extends to be rounded so as to be convex toward the outside and is positioned adjacent to the second inner wall 112. The first main extension 310a and the second main extension 310b are continuous and communicates with each other.

The first main extension 310a and the second main extension 310b may be defined in the plural number. The plurality of first main extensions 310a and the plurality of second main extensions 310b may be stacked along the height direction of the tank space 140. In the illustrated embodiment, the first main extension 310a and the second main extension 310b are stacked in the up-down direction.

In this case, the second main extension 310b is positioned adjacent to the first end 210a or the flow space 230. Specifically, the first end 210a may be positioned adjacent between the pair of second main extensions 310b positioned adjacent to each other. Accordingly, when purified water is supercooled by the refrigerant to generate ice, a space in which ice is accommodated may be secured between the first end 210a and the pair of second main extensions 310b.

In the illustrated embodiment, the main flow path 310 includes a main hollow 311, a main end 312, and an accommodation space 313.

The main hollow 311 is a space for accommodating the sub flow path 320. In addition, the main hollow 311 forms a flow path through which the refrigerant introduced from the sub flow path 320 flows. The main hollow 311 is partially formed through the inside of the main flow path 310. The main hollow 311 extends along the main flow path 310.

Among the ends in the extension direction of the main hollow 311, one end located in the tank space 140, that is, the upper end in the illustrated embodiment, is closed by the first main end 312a. Among the ends in the extension direction of the main hollow 311, the other end located outside the tank space 140, that is, the lower end in the illustrated embodiment, are formed open.

Therefore, the refrigerant passing through the sub flow path 320 may flow along a direction opposite to the direction in which it was previously flowing in the main hollow 311, by the first main end 312a. The refrigerant flowing in the main hollow 311 is heat-exchanged with the purified water of the tank space 140 as described above.

The diameter of the cross-section of the main hollow 311 may be greater than the outer diameter of the cross-section of the sub flow path 320. Accordingly, a space is formed between the cross-section of the main flow path 310 surrounding the main hollow 311 in the radial direction and the outer circumferential surface of the sub flow path 320. The refrigerant discharged from the sub flow path 320 may flow in the main hollow 311 through the space.

The main hollow 311 communicates with the sub hollow 321. The refrigerant flowing in the sub hollow 321 may be introduced into the main hollow 311.

The main hollow 311 communicates with a first branch hollow 331a and a second branch hollow 332a of the branch flow path 330. The refrigerant flowing along the main hollow 311 and heat-exchanged with purified water may flow out through the first branch hollow 331a and the second branch hollow 332a to the outside.

The main end 312 forms each end in the extension direction of the main flow path 310. The main end 312 may be defined in the plural number. In the illustrated embodiment, the main end 312 includes a first main end 312a positioned at an upper side and accommodated in the tank space 140, and a second main end 312b positioned at a lower side and located outside the tank space 140.

The first main end 312a is closed. Communication between the main hollow 311 and the tank space 140 is blocked by the first main end 312a. The Flow direction of the refrigerant flowing in the sub hollow 321 is changed by the first main end 312a so that it may flow to the outside of the tank space 140 along the main hollow 311. Therefore, the first main end 312a may function as a turning point at which the flow direction of the refrigerant is switched.

The second main end 312b is formed open. The second main end 312b is coupled to the branch flow path 330 to communicate with the first branch hollow 331a and the second branch hollow 332a, respectively. The refrigerant flowing along the main hollow 311 may pass through the second main end 312b. the first branch hollow 331a, and the second branch hollow 332a, respectively, and may flow out to the outside. Therefore, it will be understood that the second main end 312b may also be referred to as a “refrigerant outlet part 312b”.

The accommodation space 313 is a space surrounded by the main flow path 310 and formed outside the main flow path 310. The accommodation space 313 is formed surrounded by the first main extension 310a and the second main extension 310b of the main flow path 310.

The accommodation space 313 may have a shape corresponding to the shapes of the first main extension 310a and the second main extension 310b. In the illustrated embodiment, the accommodation space 313 is formed as a space having a height in the up-down direction in which the front side and the rear side thereof are rounded to be convex toward the outside, and the left side and the right side thereof extend straight in the front-rear direction.

The flow path forming part 200 is accommodated in the accommodation space 313. The first end 210a of the membrane member 210 of the flow path forming part 200 accommodated in the accommodation space 313 may be positioned adjacent to the first main extension 310a.

Therefore, it will be understood that the purified water introduced into the tank space 140 is introduced from the accommodation space 313, cooled, and then discharged.

The sub flow path 320 forms a flow path through which the refrigerant introduced from the outside flows. In other words, the sub flow path 320 forms an inlet flow path of the refrigerant. The sub flow path 320 is accommodated in the main flow path 310 and is not exposed to the tank space 140.

The refrigerant flows in the sub flow path 320 and may be adjusted such that the pressure drops. Therefore, in an embodiment, the sub flow path 320 may be referred to as a capillary tube. In the above embodiment, the sub flow path 320 may function as a throttle.

The sub flow path 320 communicates with the outside. The refrigerant for cooling the purified water may be introduced into the refrigerant flow path part 300 through the sub flow path 320. The refrigerant flowing along the sub flow path 320 flows into the main hollow 311 and exchanges heat with purified water flowing in the tank space 140.

Specifically, the refrigerant flowing along the sub flow path 320 flows in a direction from the outside of the tank space 140 toward the inside, that is, in a direction from the second sub end 322b toward the first sub end 322a. In this case, the first sub end 322a is disposed adjacent to the first main end 321a, so that the refrigerant introduced through the inside of the sub flow path 320 flows into the main flow path 310 at a position adjacent to the first main end 321a.

Therefore, the refrigerant may be introduced into the main flow path 310 in a state in which the pressure is sufficiently dropped and the enthalpy increase is minimized. Accordingly, the heat exchange efficiency between the refrigerant and the purified water may be improved.

The sub flow path 320 is accommodated in the main flow path 310. In this case, the sub flow path 320 is formed such that an outer circumferential surface thereof is spaced apart from an inner circumferential surface of the main flow path 310. To this end, the outer diameter of the cross-section of the sub flow path 320 may be less than the inner diameter of the cross section of the main flow path 310.

In an embodiment, the sub flow path 320 may be positioned radially inside the main flow path 310 and adjacent to the center of the cross-section of the main flow path 310. Alternatively, the sub flow path 320 may be positioned to be biased toward the inner circumferential surface of the main flow path 310. In any case, it is sufficient if a space for forming a refrigerant outlet flow path is formed on the outer circumferential surface of the sub flow path 320 and the inner circumferential surface of the main flow path 310.

The sub flow path 320 is coupled to the tank part 100. Specifically, the sub flow path 320 is accommodated in the main flow path 310 penetrating the tank part 100. Therefore, it may be said that the sub flow path 320 is through-coupled to the tank part 100 via the main flow path 310.

The sub flow path 320 is coupled to and communicates with the branch flow path 330. The lower end of the sub flow path 320 (i.e., the second sub end 322b to be described later) may be supported by the branch flow path 330.

The sub flow path 320 may be formed of a material having high thermal conductivity. This is to improve heat exchange efficiency between the purified water flowing outside the sub flow path 320 and the refrigerant flowing inside the sub flow path 320.

In an embodiment, the sub flow path 320 may be formed of a stainless steel (SUS) material.

The sub flow path 320 extends between the inside and the outside of the tank part 100 along the main flow path 310. In the illustrated embodiment, an upper end of the ends in the extension direction of the sub flow path 320 is located inside the tank space 140 and adjacent to the first main end 312a of the main flow path 310. A lower end of the ends in the extension direction of the sub flow path 320 is located outside the tank space 140.

In this case, the lower end of the sub flow path 320 penetrates the branch flow path 330 to be exposed to the outside. The lower end of the sub flow path 320 communicates with the outside and functions as a passage through which a refrigerant flows.

The sub flow path 320 may have an arbitrary shape in which a hollow is formed therein to allow a refrigerant to flow and which may be accommodated in the main flow path 310. In the illustrated embodiment, the sub flow path 320 is formed in a tube shape similar to the main flow path 310.

The sub flow path 320 may be divided into a plurality of portions. Some portions of the plurality of portions may be positioned adjacent to the first main extension 310a and extend along the first main extension 310a. Another some portions of the plurality of portions may be positioned adjacent to the second main extension 310b and extend along the second main extension 310b.

In the illustrated embodiment, the sub flow path 320 may be divided into a first sub extension 320a extending along the first main extension 310a and a second sub extension 320b extending along the second main extension 310b.

The first sub extension 320a extends straight and is positioned adjacent to the first sub extension 320a. The second sub extension 320b extends to be rounded so as to be convex toward the outside and is positioned adjacent to the second main extension 310b. The first sub extension 320a and the second sub extension 320b are continuous and communicates with each other.

The first sub extension 320a and the second sub extension 320b may be defined in the plural number. The plurality of first sub extensions 320a and the plurality of second sub extensions 320b may be stacked along the height direction of the tank space 140. In the illustrated embodiment, the first sub extension 320a and the second sub extension 320b are stacked in the up-down direction.

In the illustrated embodiment, the sub flow path 320 includes a sub hollow 321 and a sub end 322.

The sub hollow 321 is a space in which a refrigerant flows. The sub hollow 321 is formed through the inside of the sub flow path 320. The sub hollow 321 extends along the sub flow path 320.

Each end in the extension direction of the sub hollow 321 is formed open. Among each end in the extension direction of the sub hollow 321, one end located inside the main hollow 311, that is, the upper end in the illustrated embodiment, are formed open. The sub hollow 321 communicates with the main hollow 311 through said one end.

The other end in the extension direction of the sub hollow 321, that is, the lower end in the illustrated embodiment, is formed open. A refrigerant, that is, a refrigerant to be heat-exchanged with purified water, may be introduced into the sub hollow 321 through the other end of the sub hollow 321.

The sub hollow 321 is blocked from communicating with the first branch hollow 331a and the second branch hollow 332a of the branch flow path 330. Therefore, a refrigerant supplied from the outside may not flow into the branch flow path 330 but may only flow out through the branch flow path 330 after flowing through the main flow path 310 via said one end of the sub hollow 321.

The sub end 322 forms each end in the extension direction of the sub flow path 320. The sub end 322 may be defined in the plural number. In the illustrated embodiment, the sub end 322 includes a first sub end 322a positioned at an upper side and accommodated inside the main hollow 311, and a second sub end 322b positioned at a lower side and exposed to the outside of the branch flow path 330.

The first sub end 322a is positioned adjacent to the first main end 312a. The second sub end 322b is positioned adjacent to a branch end 333 of the branch flow path 330.

The first sub end 322a is formed open. The refrigerant flowing along the sub hollow 321 may be introduced into the main hollow 311 through the first sub end 322a. In this case, the refrigerant introduced into the main hollow 311 may flow toward the second sub end 322b by changing the flow direction by the closed first main end 312a.

The second sub and 322b is formed open. The second sub end 322b may be coupled to and communicate with an external refrigerant supply source (not shown) to receive a refrigerant. The refrigerant supplied through the second sub end 322b may flow toward the first sub end 322a along the sub hollow 321. Therefore, it will be understood that the second sub end 322b may also be referred to as a “refrigerant inlet part 322b”.

Therefore, it may be said that the refrigerant flow path part 300 has a refrigerant inlet part 322b and a refrigerant outlet part 312b respectively formed at one end of each end in the extension direction thereof, that is, at an end exposed to the lower side of the tank part 100 in the illustrated embodiment.

The branch flow path 330 is coupled to the main flow path 310 and the sub flow path 320, respectively. The branch flow path 330 supports the main flow path 310 and the sub flow path 320 on the outside of the tank part 100.

As described above, the main flow path 310 forms a flow path through which the refrigerant flows out, and the sub flow path 320 forms a flow path through which the refrigerant flows in. Therefore, as a single branch flow path 330 is configured to support both the main flow path 310 and the sub flow path 320, the refrigerant flow path part 300 may be coupled to the tank part 100 at a single point.

Accordingly, the coupling structure between the tank part 100 and the refrigerant flow path part 300 may be simplified.

The branch flow path 330 is located outside the tank part 100. In the illustrated embodiment, the branch flow path 330 is located below the tank base 130.

The branch flow path 330 is coupled to and communicates with the outside, The refrigerant flowing along the main flow path 310 may be discharged to the outside through the branch flow path 330.

The branch flow path 330 is coupled to the main flow path 310. A space for accommodating the second main end 312b of the main flow path 310 is formed inside the branch flow path 330. The space communicates with the second main end 312b and the main hollow 311 which are formed open.

The branch flow path 330 is coupled to the sub flow path 320. Specifically, the sub flow path 320 may penetrate the branch flow path 330 such that the second sub end 332b may be exposed to the outside of the branch flow path 330.

The branch flow path 330 may have an arbitrary shape capable of being coupled to the main flow path 310 and the sub flow path 320 to support them, and communicating with the main flow path 310 and the outside. In the illustrated embodiment, the branch flow path 330 is provided in the form of a fitting having the shape of the alphabet “T”.

In the illustrated embodiment, the branch flow path 330 includes a first extension 331, a second extension 332, and a branch end 333.

The first extension 331 forms one portion of the branch flow path 330. The first extension 331 is a portion at which the branch flow path 330 is coupled to the main flow path 310 and the sub flow path 320. The first extension 331 supports the main flow path 310 and the sub flow path 320.

The first extension 331 may be formed to correspond to the shape of a portion located outside the tank part 100 of each portion of the main flow path 310 and the sub flow path 320. In the illustrated embodiment, the portion of the main flow path 310 and the sub flow path 320 extend in the up-down direction. Accordingly, the first extension 331 may also extend in the up-down direction.

A first branch hollow 331a is formed through the inside of the first extension 331. The first branch hollow 331a is formed to extend in the extension direction of the first extension 331, that is, in the up-down direction in the illustrated embodiment. Bach end in the extension direction of the first branch hollow 331a, that is, the upper end and the lower end in the illustrated embodiment, are each formed open.

The second main end 312b of the main flow path 310 and a portion adjacent thereto are inserted into the first branch hollow 231a. In other words, the main flow path 310 is partially accommodated in the first branch hollow 331a. The main hollow 311 communicates with the first branch hollow 331a through the second main end 312b formed open.

The sub flow path 320 penetrates the first branch hollow 331a such that the second sub end 322b is exposed to the outside of the first extension 331. In the illustrated embodiment, the second sub end 332b is exposed downward from the first extension portion 331.

The first extension 331 is coupled to and communicates with the second extension 332. The first branch hollow 331a communicates with the second branch hollow 332a formed inside the second extension 332. In the illustrated embodiment, one side of the outer circumference of the first extension 331, that is, the rear side thereof, is continuous with the front end of the second extension 332. One side in the radial direction of the first branch hollow 331a communicates with the second branch hollow 332a.

Accordingly, the refrigerant heat exchanged with the cold water way sequentially flow out through the second main end 312b, the first branch hollow 331a, and the second branch hollow 332a.

The first extension 331 is coupled to and communicates with the branch end 333. Among the ends in the extension direction of the first extension 331, one end opposite to the tank part 100, that is, the lower end in the illustrated embodiment, is coupled to and communicates with the branch end 333.

The imer diameter of the cross-section of the first extension 331, in other words, the diameter of the cross-section of the first branch hollow 331a, may be the same as the outer diameter of the cross section of the main flow path 310. Accordingly, the second main end 312b of the main flow path 310 and a portion adjacent thereto may be hermetically coupled to the first branch hollow 331a.

In this case, the length by which the main flow path 310 is inserted may be determined according to a position where the first extension 331 is coupled to and communicates with the second extension 332. That is, as show, the main flow path 310 may be inserted into the first branch hollow 331a such that the second main end 312b into which the first branch hollow 331a is inserted does not overlap the second extension 332 or the second branch hollow 332a in the radial direction.

Accordingly, communication between the first branch hollow 331a and the second branch hollow 332a is not disturbed by the main flow path 310.

The second extension 332 forms another portion of the branch flow path 330. The second extension 332 forms a passage through which the refrigerant flowing through the main flow path 310 flows out to the outside.

The second extension 332 is coupled to and communicates with the first extension 331. The second extension 332 may extend in a direction different from that of the first extension 331 at a predetermined angle with the first extension 331. In the illustrated embodiment, the second extension 332 extends vertically with respect to the first extension 331 toward the rear side.

The second extension 332 is coupled to and communicates with an external refrigerant discharge portion (not shown). The refrigerant flowing in the main flow path 310, that is, the refrigerant already heat-exchanged with purified water, may flow out through the second extension 332 to the outside.

The second branch hollow 332a is formed through the inside of the second extension 332. The second branch hollow 332a is formed to extend in the extension direction of the second extension 332, that is, in the front-rear direction in the illustrated embodiment. Each end in the extension direction of the second branch hollow 332a, that is, the front end and the rear end in the illustrated embodiment, are each formed open.

The second branch hollow 332a communicates with the first branch hollow 331a. Accordingly, the second branch hollow 332a communicates with the second main end 312b and the main hollow 311, so that the refrigerant heat-exchanged with cold water may be introduced thereto. In the illustrated embodiment, the front end of the second branch hollow 332a communicates with the first branch hollow 331a on the rear side in the radial direction of the first branch hollow 331a.

The branch end 333 is coupled to one end of the ends in the extension direction of the first extension 331 opposite to the tank part 100, that is, the lower end in the illustrated embodiment. The branch end 3330 is configured to support a part of the sub flow path 320 through-coupled to the first extension 3310, that is, a part adjacent to the second sub end 322b in the illustrated embodiment.

The branch end 333 is formed to extend in the extension direction of the first extension 331, that is, in the up-down direction in the illustrated embodiment.

The branch end 333 is coupled to and communicates with the first extension 331. A hollow is formed through the branch end 333 in the extension direction, that is, in the up-down direction in the illustrated embodiment. The hollow communicates with the first branch hollow 331a.

The sub flow path 320 may penetrate the first branch hollow 331a and the hollow such that the second sub end 322b may be exposed to the outside of the branch flow path 330. In the illustrated embodiment, the second sub end 332b is exposed downward from the branch flow path 330.

The branch flow path 330 may be formed to have a cross-sectional area changed along the extension direction thereof. In the illustrated embodiment, the branch flow path 330 is formed to have a cross-sectional area reduced in a direction opposite to the tank part 100, that is, in a downward direction. In other words, the branch flow path 330 is tapered toward the lower side.

In this case, the inner diameter of the cross-section of the lower end of the branch flow path 330 may be formed equal to the outer diameter of the cross-section of the sub flow path 320. In the above embodiment, the sub flow path 320 is supported by the branch flow path 330, but communication between the first branch hollow 331a and the branch end 333 communicating therewith and the outside may be blocked.

Accordingly, the refrigerant introduced into the first branch hollow 331a does not flow out through the hollow of the branch end 333 to the outside.

In the above-described refrigerant flow path part 300, the refrigerant introduced through the second sub end 322b of the sub flow path 320 flows along the sub flow path 320 and flows into the main hollow 311 through the first sub end 322a.

In this case, the sub flow path 320 extends along the main flow path 310 inside the main flow path 310, so that the first sub end 322a is located adjacent to the first main end 312a of the main flow path 310. That is, the first sub end 322a through which the refrigerant flows out from the sub hollow 321 toward the main hollow 311 is located in the tank space 140.

The flow direction of the refrigerant introduced into the main hollow 311 is changed by the first main end 312a. The refrigerant introduced into the main hollow 311 may flow in a direction from the first main end 312a toward the second main end 312b, and cool purified water.

Therefore, both the inlet flow path and the outlet flow path of the refrigerant may be formed by a single main flow path 310 and a sub flow path 320 accommodated therein.

The cold water tank assembly 10 according to an exemplary embodiment of the present invention described above includes a tank part 100 into which purified water is introduced and a refrigerant flow path part 300 partially accommodated in the tank part 100 to form a refrigerant flow path. The refrigerant flow path part 300 includes a branch flow path 330 simultaneously supporting the refrigerant inlet flow path and the refrigerant outlet flow path, and is coupled to the tank part 100 at a single point.

Accordingly, the sealed state of the tank part 100 can be reliably maintained, and the simplification of the structure of the tank part 100 can be achieved.

In addition, the sub flow path 320 that functions as a capillary tube extends along the main flow path 310 inside the main flow path 310 that functions as an evaporator so that an end thereof (i.e., the first sub end 322a) is located inside the tank space 140.

Therefore, the introduced refrigerant may flow along the sub flow path 320 and enter the main flow path 310 while the pressure is sufficiently lowered but the enthalpy increase is minimized. In addition, the flow-out refrigerant may flow along the main flow path 310 and flow out while cooling purified water. As a result, the cooling efficiency of the purified water may be improved.

In addition, the flow path forming part 200 is accommodated inside the tank part 100. The flow path forming part 200 partitions the tank space 140 into a plurality of small spaces communicating with each other. In this case, the plurality of partitioned small spaces communicate at different positions so that a zigzag flow path is formed in the tank space 140.

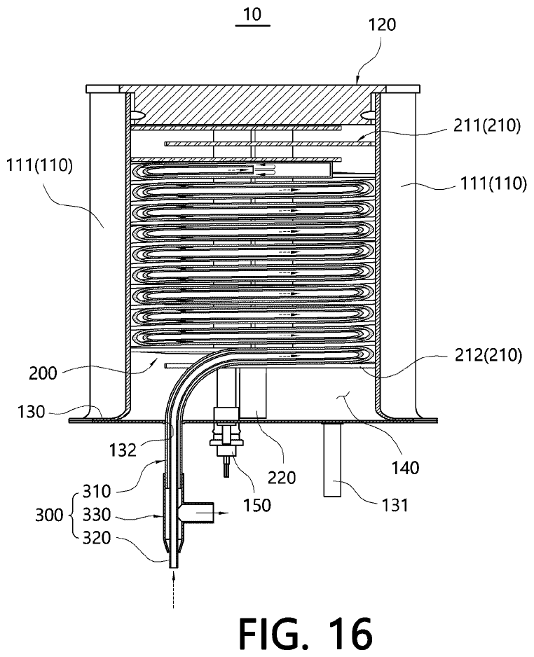

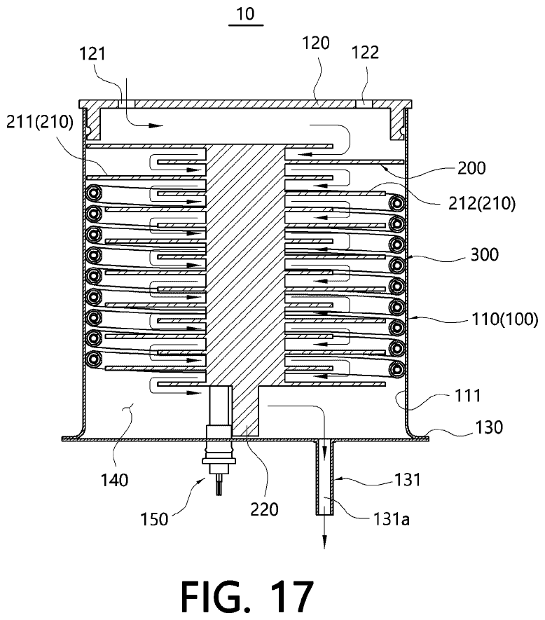

Hereinafter, a flow path of a refrigerant and a flow path of purified water formed in the cold water tank assembly 10 according to an exemplary embodiment of the present invention will be described in detail with reference to FIGS. 16 to 17.

Referring to FIG. 16, a flow path of a refrigerant formed inside the cold water tank assembly 10 according to an exemplary embodiment of the present invention is illustrated.

The refrigerant flow path part 300 may communicate with the outside to introduce a refrigerant to be heat-exchanged with purified water. In addition, the refrigerant flow path part 300 may communicate with the outside to flow out the refrigerant heat-exchanged with purified water.

Specifically, a refrigerant is supplied from the outside through the sub flow path 320. In this case, the second sub end 322b may be exposed to the outside of the branch end 333 to be coupled to and communicate with an external refrigerant supply source (not shown).

The refrigerant introduced into the sub hollow 321 through the second sub end 322b flows toward the first sub end 322a. The first sub end 322a is formed to be open and communicates with the main hollow 311, and thus a refrigerant is introduced into the main hollow 311. That is, the refrigerant inlet flow path is formed in a direction from the second sub end 322b toward the first sub end 322a.

In this case, the first main end 312a positioned adjacent to the first sub end 322a is formed closed. Therefore, the refrigerant does not flow along the above direction, but the flow direction is changed toward the second main end 312b, that is, toward the lower side in the illustrated embodiment.

Meanwhile, the main flow path 310 is accommodated in the tank space 140 and exposed. Therefore, purified water introduced into the tank space 140 is heat-exchanged with a refrigerant flowing from the first main end 312a toward the second main end 312b along the main hollow 311. That is, the outlet flow path of the refrigerant is formed in a direction from the first main end 312a toward the second main end 312b.

The second main end 312b is inserted into and coupled to the first extension 331 of the branch flow path 330. In this case, the second main end 312b communicates with the first branch hollow 331a, so that the refrigerant flowing along the main hollow 311 (i.e., the refrigerant heat-exchanged with purified water) is introduced into the first branch hollow 331a.

The hollow of the branch end 333 communicating with the first branch hollow 331a is blocked from communicating with the outside by the sub flow path 320 which is through-coupled thereto. Therefore, the refrigerant introduced into the first branch hollow 331a may flow out to an external refrigerant discharge portion (not shown) through the second branch hollow 332a.

In this case, both the main flow path 310 and the sub flow path 320 are supported by the branch flow path 330. Therefore, the refrigerant flow path part 300 may be coupled to the tank base 130 at a single point (i.e., the flow path through portion 132). As a result, a portion through which the refrigerant flow path part 300 is coupled to the tank part 100 may be minimized.

Referring to FIG. 17, a flow path of purified water formed inside the cold water tank assembly 10 according to an exemplary embodiment of the present invention is illustrated. In this case, the purified water flows in the cold water tank assembly 10 and is cooled to form cold water, so it will be understood that the flow path may also be referred to as “a flow path of produced cold water”.

First, purified water filtered by an external filter member is introduced into the tank space 140 through the water inlet portion 121. In this case, the tank space 140 is partitioned into a plurality of small spaces by the flow path forming part 200.

The first end 210a of the first membrane member 211 is positioned below the water inlet portion 121. The first end 210a is in close contact with the first inner wall 111, and thus purified water does not flow into a space between the first end 210a and the first inner wall 111. Therefore, the purified water introduced into the tank space 140 through the water inlet portion 121 flows in the extension direction of the first membrane member 211, that is, toward the rear side in the illustrated embodiment and flows to the second end 210b.

As described above, each edge in the width direction of the membrane member 210 may be in close contact with the second inner wall 112. Therefore, purified water flowing along the membrane member 210 may flow to an adjacent separation space 240 only through the flow space 230 formed between the second end 210b and the first inner wall 111.

In this case, in the case of the plurality of membrane members 210, the first end 210a; the second end 210b; and the flow space 230 formed between the second end 210b and the first inner wall 111 are alternately arranged in the longitudinal direction thereof. Therefore, purified water passing through the flow space 230 adjacent to the second end 210b of any one membrane member 210 may flow through the separation space 240 in the longitudinal direction of the membrane member 210 and then be introduced into another flow space 230.

Accordingly, a zigzag-shaped purified water flow path is formed in the tank space 140. As a result, the heat exchange time between the flowing purified water and the refrigerant may be sufficiently secured, thereby improving the cooling efficiency of the purified water.

In addition, as the flow path of the purified water is formed in a zigzag shape, the flow rate of the purified water does not increase excessively. Therefore, when the user performs cold water extraction, a situation in which a large amount of cold water is unintentionally discharged may be prevented, thereby improving user satisfaction.

Although exemplary embodiments of the present invention have been described, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the scope of the present invention.
10: cold water tank assembly 100: tank part
110: tank body 111: first inner wall
112: second inner wall 120: tank cover
121: water inlet portion 122: gas communication portion
130: tank base 131: water outlet portion
131a: water outlet through hole 132: flow path through portion
133: sensor coupling portion 140: tank space
150: sensor member 200: flow path forming part
210: membrane member 210a: first end
210b: second end 211: first membrane member
212: second membrane member 220: column member
230: flow space 240: separation space
300: refrigerant flow path part 310: main flow path
310a: first main extension 310b: second main extension
311: main hollow 312: main end
312a: first main end 312b: second main end
313: accommodation space 320: sub flow path
320a: first sub extension 320b: second sub extension
321: sob hollow 322: sub end
322a: first sub end 322b: second sub end
330: branch flow path 331: first extension
331a: first branch hollow 332: second extension
332a: second branch hollow 333: branch end

1. A cold water tank assembly, comprising:
a tank configured to communicate with outside to enable filtered water to be introduced, cooled, and then discharged; and
a refrigerant flow path accommodated in the tank and through which refrigerant exchanging heat with the filtered water flows,
wherein a first end of the refrigerant flow path is extended to be located inside the tank,
wherein a second end of the refrigerant flow path is located outside the tank, and
wherein the refrigerant flow path is coupled through the tank at a single point.

2. The cold water tank assembly of claim 1;
wherein the refrigerant flow path comprises:
a main flow path configured to form a flow path for discharging the refrigerant from the first end of the refrigerant flow path to the second end of the refrigerant flow path, and to transfer heat to the refrigerant in a mixed state of liquid and gas; and
a sub flow path disposed inside the main flow path, configured to extend in the same direction as the main flow path to form a flow path for introducing the refrigerant flows from the second end of the refrigerant flow path to the first end of the refrigerant flow path part, and configured to lower pressure of the refrigerant in a mixed state of liquid and gas or in a liquid state.

3. The cold water tank assembly of claim 2,
wherein the main flow path comprises:
a first main end positioned inside the tank and formed closed; and
a second main end positioned outside the tank and formed open, and
wherein the sub flow path comprises:
a first sub end positioned adjacent to the first main end inside the tank and formed open to communicate with the main flow path; and
a second sub end positioned outside the tank and formed open to receive the refrigerant from the outside.

4. The cold water tank assembly of claim 2,
wherein the tank comprises;
a tank space configured to accommodate the refrigerant flow path; and
a tank body configured to surround the tank space, and
wherein among portions of the main flow path and the sub flow path, a portion disposed in the tank space extends in a spiral shape.

5. The cold water tank assembly of claim 4, wherein the main flow path extends to be located adjacent to an inner wall of the tank body surrounding the tank space.

6. The cold water tank assembly of claim 1,
wherein the tank comprises:
a tank space configured to accommodate the refrigerant flow path; and
a tank base disposed to cover the tank space from one side, and
wherein the first end of the refrigerant flow path in an extension is positioned in the tank space and extends to penetrate the tank base, and the second end in the extension direction of the refrigerant flow path is disposed outside the tank space.

7. The cold water tank assembly of claim 6,
wherein the refrigerant flow path comprises:
a main flow path through-coupled to the tank base and having the first end formed closed and the other end formed open;
a sub flow path extending along the main flow path inside the main flow path, wherein a first end formed open in the extension direction of the sub flow path is disposed adjacent to the first end of the main flow path, and the second end formed open in the extension direction of the sub flow path is exposed to the outside of the tank; and
a branch flow path coupled to the second end of the main flow path to communicate with the main flow path and coupled to a portion adjacent to the second end of the sub flow path.

8. The cold water tank assembly of claim 7,
wherein the branch flow path comprises:
a first extension extending along the extension direction of the main flow path and coupled to the second end of the main flow path;
a second extension extending in a direction different from the first extension and communicating with the first extension to form a flow path through which the refrigerant is discharged; and
a branch end forming a one end opposite to the main flow path among ends in the extension direction of the first extension.

9. The cold water tank assembly of claim 8,
wherein a cross-sectional area of one end, opposite to the main flow path, of ends in the extension direction of the branch end is formed to be less than or equal to a cross-sectional area of the sub flow path,
so that communication between the inside and the outside of the main flow path is blocked.

10. The cold water tank assembly of claim 7,
wherein the main flow path comprises:
a main hollow formed as a space extending between the first end and the second end,
wherein the sub flow path comprises:
a sub hollow formed as a space extending between the first end and the second end, and through which the refrigerant introduced from the outside flows, and
wherein the first end of the sub flow path communicates with the main hollow,
so that the refrigerant is introduced through the second end of the sub flow path, flows through the sub hollow, and flows out to the main hollow through the first end.

11. The cold water tank assembly of claim 10, wherein the refrigerant flowing out from the sub hollow flows through the main hollow and flows out into the branch flow path through the second end of the main flow path.

12. The cold water tank assembly of claim 11,
wherein the branch flow path comprises:
a first extension coupled to the second end of the main flow path to communicate with the main hollow and through which the sub flow path passes; and
a second extension communicating with the first extension to form a passage through which the refrigerant flowing out from the second end of the main flow path is discharged to the outside.

13. The cold water tank assembly of claim 1,
wherein the tank comprises:
a tank space through which the filtered water flows and which accommodates the refrigerant flow path;
a tank body configured to surround the tank space from the outer circumferential direction; and
a flow path former disposed in the tank space to face the tank body with the refrigerant flow path interposed therebetween to form a space in which the introduced filtered water flows.

14. The cold water tank assembly of claim 13,
wherein the flow path former comprises:
a plurality of membranes extending in the longitudinal direction of the tank body and stacked apart from each other in the height direction of the tank body; and
a column extending in the height direction of the tank body and coupled to each of the plurality of membranes.

15. The cold water tank assembly of claim 14,
wherein each of the membranes comprises:
a first end forming one end in the extension direction thereof, and positioned adjacent to the refrigerant flow path; and
a second end forming the other end in the extension direction thereof, and positioned spaced apart from the refrigerant flow path.

16. The cold water tank assembly of claim 15,
wherein the flow path former comprises:
a flow space positioned between the second end and the refrigerant flow path, and in which the filtered water flowing in one membrane of adjacent membranes flows out to another membrane; and
a separation space communicating with the flow space, and formed between adjacent membranes and in which the filtered water flows.

17. The cold water tank assembly of claim 15, wherein the second ends of the membranes adjacent to each other are disposed to be biased to different sides along the longitudinal direction of the tank body.
